(19) United States
(12) Patent Application Publication
(10) Pub. No.: US 2026/0196719 A1
(43) Pub. Date: Jul. 9, 2026

(54) ACTIVE ANTENNA UNIT AND COMMUNICATION DEVICE

(71) Applicant: HUAWEI TECHNOLOGIES CO., LTD., Shenzhen (CN)

(72) Inventors: Xianghua Li, Shanghai (CN); Guanxi Zhang, Shanghai (CN); Long Shen, Shanghai (CN); Shipeng Hu, Dongguan (CN)

(21) Appl. No.: 19/558,904

(22) Filed: Mar. 6, 2026

Related U.S. Application Data
(63) Continuation of application No. PCT/CN2024/111852, filed on Aug. 13, 2024.

(30) Foreign Application Priority Data
Sep. 11, 2023 (CN) 202311170063.7

(51) Int. Cl. H01Q 1/52; H01Q 1/22; H01Q 3/36

(52) U.S. Cl. CPC H01Q 1/523; H01Q 1/22; H01Q 3/36

(57) ABSTRACT

An active antenna unit includes N radio frequency antenna links and L self-interference cancellers, where N is an integer greater than 1, and L is an integer less than or equal to N. Each radio frequency antenna link includes: a transmit channel, a receive channel, a feed network, and an antenna subarray. The N radio frequency antenna links meet at least one of the following: Traces of feed networks of at least two radio frequency antenna links are different; or an isolation assembly is disposed between N antenna subarrays, and is configured to isolate a signal between the N antenna subarrays. In addition, a self-interference canceller is connected between a transmit channel and a receive channel of at least one link, and is configured to cancel a signal that is from the transmit channel and that is on the receive channel of the link.

### CROSS-REFERENCE TO RELATED APPLICATIONS

This application is a continuation of International Application No. PCT/CN 2024/111852, filed on Aug. 13, 2024, which claims priority to Chinese Patent Application No. 202311170063.7, filed on Sep. 11, 2023, the disclosures of the aforementioned applications are hereby incorporated by reference in their entireties.

### TECHNICAL FIELD

This application relates to the field of wireless communication, and in particular, to an active antenna unit and a communication device.

### BACKGROUND

A working mode in a communication system includes a plurality of working modes such as time division duplex (time division duplex, TDD), frequency division duplex (frequency division duplex, FDD), full duplex, subband duplex, and partial full duplex. In some working modes, for example, the full duplex, the subband duplex, and the partial full duplex, a base station may use a same group or a plurality of groups of antenna units to simultaneously transmit a signal and receive a signal, that is, an antenna is for both reception and transmission. A device whose antenna is for both reception and transmission receives an uplink signal while transmitting a downlink signal. Therefore, the device receives the downlink signal transmitted by the device, and the received downlink signal is coupled to a receive link. Due to high transmit power of the downlink signal, the receive link is blocked, degrading receive performance.

To avoid blocking of the receive link, a self-interference canceller (self-interference cancellation) is usually used to reduce interference of the downlink signal received on the receive link. There are a plurality of links in the self-interference canceller, and each link includes devices such as an adjustable phase shifter and an adjustable attenuator and further includes a delayer. This results in high cabling complexity and increased control complexity.

Currently, a base station whose antenna is for both reception and transmission usually uses an N (N is a positive integer) transmit and N receive architecture, to be specific, the base station uses N groups of antenna units to simultaneously send a downlink signal and receive an uplink signal. Common designs include one transmit and one receive, two transmit and two receive, four transmit and four receive, and the like. The four transmit and four receive is used as an example. While transmitting signals by using four groups of antenna units, the base station may use the four groups of antenna units to receive signals. When receiving an uplink signal, each group of antenna units not only receives a downlink signal transmitted by the group of antenna units, but also receives downlink signals transmitted by the other three groups of antenna units. To avoid blocking of the receive link, the self-interference canceller needs to be used between each transmit link and each receive link to reduce interference. Therefore, 4×4 self-interference cancellers, that is, N×N self-interference cancellers, need to be used.

As a quantity of antenna units for both reception and transmission increases, a value of N tends to increase, leading to a sharp increase in a quantity of self-interference cancellers and a significant rise in complexity.

### SUMMARY

One or more embodiments of the present application provide an active antenna unit (active antenna unit, AAU) and a communication device, to reduce circuit complexity in the AAU, and reduce control complexity.

According to a first aspect, an AAU is provided. In some embodiments, the AAU may be used in a communication device, for example, a network device or a terminal device. In the following descriptions, for ease of distinguishing a signal on a transmit channel and a signal on a receive channel, a direction of a signal is described by using the network device as an example. For example, the signal transmitted on the transmit channel is a downlink signal, and the signal received on the receive channel is an uplink signal. It may be understood that, in different communication devices, the direction of the signal also changes correspondingly. For example, for the terminal device, the signal transmitted on the transmit channel is an uplink signal, and the signal received on the receive channel is a downlink signal. The following descriptions shall not constitute any limitation on the direction of the signal and the communication device in which the AAU is used.

For example, the AAU includes N radio frequency antenna links and L self-interference cancellers, where N is an integer greater than 1, and Lis a positive integer less than or equal to N. Each of the N radio frequency antenna links includes a transmit channel, a receive channel, a feed network connected to the transmit channel and the receive channel, and an antenna subarray connected to the feed network, the feed network is configured to feed power to the antenna subarray, and the antenna subarray is configured to: transmit a signal and receive a signal. A self-interference canceller is connected between a transmit channel and a receive channel of at least one of the N radio frequency antenna links, and the self-interference canceller is configured to cancel a signal that is from the transmit channel of the same radio frequency antenna link and that is on the receive channel of the radio frequency antenna link of the self-interference canceller. The N radio frequency antenna links meet at least one of the following: traces of feed networks of at least two of the N radio frequency antenna links are different; or an isolation assembly is disposed between N antenna subarrays of the N radio frequency antenna links, and the isolation assembly is configured to isolate a signal between the N antenna subarrays.

In some embodiments, each antenna subarray may include a plurality of antenna elements (or referred to as elements for short). Each antenna subarray is configured to: transmit the signal and receive the signal. Actually, the plurality of antenna elements in each antenna subarray are configured to: send the signal and receive the signal. In this way, each antenna subarray may perform sending and receiving on a same time-frequency resource. In other words, each antenna subarray is for both reception and transmission, or the antenna elements in each antenna subarray are for both reception and transmission.

The network device is used as an example. For a downlink signal transmitted by an antenna subarray, another antenna subarray near the antenna subarray may be considered as a receiver. For ease of differentiation and description, the antenna subarray that transmits the downlink signal is denoted as a sender antenna subarray, and an antenna subarray that receives the downlink signal is denoted as a receiver antenna subarray. It may be understood that sending and receiving are relative, and each antenna subarray may be the sender antenna subarray, or may be the receiver antenna subarray. Each receiver antenna subarray may simultaneously receive downlink signals of a plurality of sender antenna subarrays, or may simultaneously send downlink signals while performing receiving.

In some embodiments of this solution, that traces of feed networks of different radio frequency antenna links are different may specifically mean that layouts of radio frequency lines in print circuit boards (print circuit boards, PCBs) of different radio frequency antenna links are different. The radio frequency line may feed a to-be-sent signal to an antenna element based on a specific amplitude and a specific phase, or send a received signal to a processing unit of the communication device (for example, a base station) based on a specific amplitude and a specific phase. That the layouts of the radio frequency lines are different may include: Lengths of the radio frequency lines are different, and/or widths of the radio frequency lines are different. Phases and/or amplitudes of downlink signals sent on different radio frequency antenna links can be different by making different designs for the lengths and/or the widths of the radio frequency lines.

Therefore, when traces of feed networks of at least two radio frequency antenna links (for example, including a radio frequency antenna link on which a sender antenna subarray is located and a radio frequency antenna link on which the receiver antenna subarray is located) are different, by designing a feed network of the sender antenna subarray, when the sender antenna subarray transmits downlink signals, phases of signals received by different antenna elements in the receiver antenna subarray in a near field of the sender antenna subarray are opposite, vectors are canceled, and energy is reduced, and therefore, energy of the downlink signals received by the receiver antenna subarray is reduced, and interference is reduced. In addition, by designing a feed network of the receiver antenna subarray, after each antenna element in the receiver antenna subarray receives the downlink signals, the vectors may further be canceled in a circuit domain, so that the energy of the downlink signals is further reduced, and the interference is further reduced.

Mutual interference between different antenna subarrays may also be isolated by disposing an isolation assembly for the antenna subarrays.

In addition, to reduce interference of the downlink signal in the link on the receive channel, the self-interference canceller may be connected between the receive channel and the transmit channel, to reduce the interference from the downlink signal of the link. In some embodiments, a self-interference canceller may be connected between a receive channel and a transmit channel of at least one of the N radio frequency antenna links. In this way, one or more self-interference cancellers are introduced into the N radio frequency antenna links, to further reduce the interference of the downlink signal on the receive channel.

Based on a design of the feed network and a design of disposing the isolation assembly for the antenna subarrays, the mutual interference between the different antenna subarrays can be reduced, that is, mutual interference between the different radio frequency antenna links can be reduced. In this way, interference received on the receive channel of each radio frequency antenna link is mainly from the downlink signal of the transmit channel of the link. Therefore, the self-interference canceller may be connected between the transmit channel and the receive channel of the radio frequency antenna link, to cancel the downlink signal from the transmit channel of the link, so as to reduce the interference on the receive channel. In other words, in the solution provided in some embodiments, there is no need to connect self-interference cancellers between transmit channels and receive channels of any two different radio frequency antenna links in the N radio frequency antenna links. This greatly reduces a quantity of self-interference cancellers, thereby lowering control complexity as well as circuit complexity.

In some embodiments, N is equal to L. In other words, a self-interference canceller is connected between a receive channel and a transmit channel of each of the N radio frequency antenna links.

In other words, the N radio frequency antenna links may be in one-to-one correspondence with N self-interference cancellers, and each self-interference canceller is connected in a corresponding radio frequency antenna link. In comparison with current use of N×N self-interference cancellers in the N radio frequency antenna links, a quantity of self-interference cancellers is greatly reduced, and circuit complexity is reduced.

Therefore, according to the solution provided in in some embodiments of this application, blocking of the receive channel by the downlink signal causing the interference can be reduced in each radio frequency antenna link and between different radio frequency antenna links, thereby helping obtain good receive performance.

It may be understood that the two manners of the design of the feed network and disposing the isolation assembly for the antenna subarrays may be implemented separately, or may be implemented in combination. The two manners are implemented in combination, so that the mutual interference between the different antenna subarrays can be reduced to a greater extent, and the blocking of the downlink signal on the receive channel can be reduced, thereby mitigating deterioration of the receive performance and obtaining better receive performance.

With reference to the first aspect, in some embodiments of the first aspect, the feed network in each of the N radio frequency antenna links includes one or more phase shifters, and each phase shifter is connected to one or more antenna elements.

Each phase shifter may be connected to the one or more antenna elements, may be configured to adjust a beam direction of a downlink signal transmitted by the connected one or more antenna elements, and may be further configured to adjust a phase of the downlink signal transmitted by the connected one or more antenna elements. Because the phase shifter may be configured to adjust a beam direction of a signal, more antenna elements may be used in an antenna subarray to receive a signal and send a signal. An increase in a quantity of antenna elements in an antenna array may cause greater freedom of the feed network. In other words, the feed network may have greater freedom to optimize an amplitude and/or a phase of the signal, to provide powerful support for optimizing higher isolation.

In addition, the phase shifter may be configured to adjust the phase, so that a phase difference also exists between downlink signals transmitted by antenna elements connected to different phase shifters in a same antenna subarray. Therefore, the downlink signals transmitted by the different antenna elements may be mutually canceled by controlling the phase difference, thereby reducing mutual interference.

With reference to the first aspect, in some embodiments of the first aspect, the isolation assembly includes M decoupling units located above the N antenna subarrays, and M is an integer greater than or equal to N. A decoupling unit located above a first antenna subarray is configured to reflect a part of a received signal, to cancel, by using the reflected signal, a signal that is from another antenna subarray and that is in a first receive channel, the first antenna subarray is any one of the N antenna subarrays, the first receive channel is a receive channel connected to the first antenna subarray, and the another antenna subarray is one or more of antenna subarrays in the N antenna subarrays other than the first antenna subarray.

M may be an integer multiple of N, or may not be an integer multiple of N. The M decoupling units may be evenly distributed, and cover the N antenna subarrays, to form an antenna decoupling surface (antenna decoupling surface, ADS). The ADS cancels a coupled signal between adjacent antenna subarrays by creating a new reflected signal (that is, generated by reflecting the part of the received signal). Therefore, the M decoupling units are disposed above the N antenna subarrays, so that isolation between the N antenna subarrays can be improved by suppressing mutual coupling between the antenna subarrays.

With reference to the first aspect, in some embodiments of the first aspect, the isolation assembly includes at least one isolation unit located between adjacent antenna subarrays in the N antenna subarrays, and the at least one isolation unit located between the adjacent antenna subarrays is configured to isolate an interference signal between at least some of the N antenna subarrays.

The isolation unit may be disposed between the adjacent antenna subarrays, to reduce interference between the antenna subarrays and improve isolation between the antenna subarrays in a manner like performing energy absorption, changing phases or amplitudes, or the like for downlink signals transmitted by the antenna subarrays.

Each of the N antenna subarrays includes a plurality of antenna elements, the isolation assembly further includes at least one isolation unit located between adjacent antenna elements in each antenna subarray, and the at least one isolation unit located between the adjacent antenna elements is configured to isolate an interference signal between at least some of the plurality of elements.

The isolation unit may further be disposed between the adjacent antenna elements, to reduce interference between the antenna elements and improve isolation between the antenna elements.

In some embodiments, the at least one isolation unit is made of one or more of a wave-absorbing material, a scattering material, and a metamaterial.

The wave-absorbing material may absorb or greatly weaken electromagnetic wave energy received on a surface of the wave-absorbing material. Therefore, the wave-absorbing material can be used to make the isolation unit. Both the scattering material and the metamaterial can be used to control amplitudes and phases of electromagnetic waves, and change scattering paths and reflection paths of the electromagnetic waves, to achieve an effect of canceling downlink signals, and therefore can be used to make the isolation unit.

In some embodiments, each isolation unit may be made of one of the wave-absorbing material, the scattering material, and the metamaterial. When the isolation assembly includes a plurality of isolation units, different isolation units may be made of a same material, for example, one of the wave-absorbing material, the scattering material, and the metamaterial; or different isolation units may be made of different materials, for example, more of the wave-absorbing material, the scattering material, and the metamaterial.

With reference to the first aspect, in some embodiments of the first aspect, the receive channel of each radio frequency antenna link includes a low noise amplifier (low noise amplifier, LNA), an analog-to-digital converter (analog-to-digital converter, ADC), and a narrow band filter connected between the ADC and the LNA, and the narrow band filter is configured to filter out a signal outside a preset frequency.

In other words, the narrow band filter may allow a signal of a preset frequency to pass through, and filter out a signal of another frequency, so that interference of the signal that passes through is small. In this way, the ADC is slightly affected by another signal, the ADC is not saturated, an entire receive link is not blocked, and receive performance is slightly affected.

In some embodiments, the preset frequency may be an uplink frequency.

In other words, a signal other than an uplink signal cannot pass through the narrow band filter. Connecting a narrow band filter in the receive link is particularly applicable to a working mode in which different frequency bands are used for uplink and downlink, for example, a subband-duplex working mode.

Further, the receive channel of each radio frequency antenna link further includes a switch element, and the switch element is configured to control a received signal to flow to the ADC through or not through the narrow band filter.

The switch element is connected on the receive channel, to flow to the ADC through different paths in different working modes. For example, in the subband-duplex working mode, a control signal flows from the narrow band filter to the ADC, that is, a downlink signal is filtered out by the narrow band filter. In working modes such as TDD and FDD, the control signal flows to the ADC through the switch element instead of the narrow band filter.

With reference to the first aspect, in some embodiments of the first aspect, at least two of the N antenna subarrays are separately connected to an ADC on a same receive channel through phase shifters, and the phase shifter is configured to adjust phases of an uplink signal and a downlink signal that are received by a connected antenna subarray.

In other words, a plurality of antenna subarrays are separately connected to a same ADC through phase shifters. Different antenna subarrays may adjust phases through phase shifters. Therefore, in-phase superposition for uplink signals can be enhanced, and out-of-phase cancellation for downlink signals can be implemented through the adjustment of the phases.

In a possible design, the N antenna subarrays are separately connected to an ADC on a same receive channel through phase shifters, and an ADC on a receive channel of the N radio frequency antenna links is connected to the N antenna subarrays.

According to the foregoing design, the N antenna subarrays may be combined with one receive channel. In this way, phases of the N antenna subarrays may be adjusted (or optimized), to enhance uplink signals and weaken downlink signals on a same receive channel. In addition, on a receive channel of each of N radio frequency antenna links, uplink signals can be enhanced and downlink signals can be weakened in a same manner.

In some embodiments, an objective of phase adjustment is to perform in-phase superposition on the uplink signals and perform out-of-phase cancellation on the downlink signals through the adjustment. The in-phase superposition on the uplink signals means that uplink signals from different antenna subarrays are superimposed in phase and energy is enhanced. That the uplink signals from the different antenna subarrays are in phase may specifically mean that there is a phase difference of an integer multiple of 27 between the uplink signals from the different antenna subarrays. The out-of-phase cancellation on the downlink signals means that downlink signals from different antenna subarrays are canceled out of phase and energy is weakened. That the downlink signals from the different antenna subarrays are out of phase may specifically mean that there is a phase difference of an odd multiple of a between the downlink signals from the different antenna subarrays.

That the phase difference between the uplink signals from the different antenna subarrays is the integer multiple of 2x, and the phase difference between the downlink signals from the different antenna subarrays is the odd multiple of It is an ideal objective of the phase adjustment. In an actual application, continuous adjustment and optimization may be performed, so that the phase difference between the uplink signals from the different antenna subarrays approaches the integer multiple of 27, and the phase difference between the downlink signals from the different antenna subarrays approaches the odd multiple of I.

According to a second aspect, an AAU is provided. The AAU may be used in a communication device, for example, a network device or a terminal device.

For example, the AAU includes N radio frequency antenna links, where N is an integer greater than 1. Each of the N radio frequency antenna links includes a transmit channel, a receive channel, a feed network connected to the transmit channel and the receive channel, and an antenna subarray connected to the feed network, the feed network is configured to feed power to the antenna subarray, and the antenna subarray is configured to: transmit a signal and receive a signal. The receive channel of each radio frequency antenna link includes an LNA, a narrow band filter, and an ADC, and the narrow band filter is connected between the LNA and the ADC and is configured to filter out another signal not at a preset frequency.

In other words, the narrow band filter may allow a signal of a preset frequency to pass through, and filter out a signal of another frequency, so that interference of the signal that passes through is small. In the foregoing solution, the narrow band filter is added on the receive channel to filter out the signal, so that energy of an interference signal entering the ADC is low, the ADC is slightly affected by the interference signal, the ADC is not saturated, an entire receive link is not blocked, and receive performance is slightly affected.

In some embodiments, the preset frequency is an uplink frequency.

In other words, a signal other than an uplink signal cannot pass through the narrow band filter. Connecting a narrow band filter in the receive link is particularly applicable to a working mode in which different frequency bands are used for uplink and downlink, for example, a subband-duplex working mode.

With reference to the second aspect, in some embodiments of the second aspect, the receive channel of each radio frequency antenna link further includes a switch element, and the switch element is configured to control a received signal to flow to the ADC through or not through the narrow band filter.

The switch element is connected on the receive channel, to flow to the ADC through different paths in different working modes. For example, in a subband-duplex working mode, a control signal flows from the narrow band filter to the ADC, that is, a downlink signal is filtered out by the narrow band filter. In working modes such as TDD and FDD, the control signal flows to the ADC through the switch element instead of the narrow band filter.

According to a third aspect, an AAU is provided. The AAU may be used in a communication device, for example, a network device or a terminal device.

For example, the AAU includes N radio frequency antenna links, where N is an integer greater than 1. Each of the N radio frequency antenna links includes a transmit channel, a receive channel, a feed network connected to the transmit channel and the receive channel, and an antenna subarray connected to the feed network, the feed network is configured to feed power to the antenna subarray, and the antenna subarray is configured to: transmit a signal and receive a signal. At least two of the N antenna subarrays are separately connected to an ADC on a same receive channel through phase shifters, and the phase shifter is configured to adjust phases of an uplink signal and a downlink signal that are received by a connected antenna subarray.

In other words, a plurality of antenna subarrays are separately connected to a same ADC through phase shifters. Different antenna subarrays may adjust phases through phase shifters. Therefore, a part of a signal can be enhanced, and a part of a signal can be weakened through the adjustment of the phases. The network device is used as an example to enhance the uplink signal and weaken the downlink signal. For descriptions of a principle of signal enhancement and weakening through the phase adjustment, refer to the related descriptions in the first aspect. Details are not described again.

In the foregoing solution, the plurality of antenna subarrays are separately connected to the same receive channel through the phase shifters, to enhance the part of the signal, and weaken the part of the signal through the adjustment of the phases, so that energy of an interference signal entering the ADC is low, the ADC is slightly affected by the interference signal, the ADC is not saturated, an entire receive link is not blocked, and receive performance is slightly affected.

With reference to the third aspect, in some embodiments of the third aspect, the N antenna subarrays are separately connected to an ADC on a same receive channel through phase shifters, and an ADC on a receive channel of the N radio frequency antenna links is connected to the N antenna subarrays.

According to the foregoing design, the N phase shifters connected to the N antenna subarrays may respectively perform phase adjustment (or optimization) on signals of the antenna subarrays connected to the N phase shifters, so that on each of the N receive channels, an uplink signal can be enhanced and a downlink signal can be weakened, thereby helping improve receive performance.

According to a fourth aspect, a communication device is provided, and includes a baseband unit (baseband unit, BBU) and the AAU in any one of the first aspect to the third aspect and the embodiments of the first aspect to the third aspect.

In some embodiments, the communication device is a network device.

In some embodiments, the communication device is a terminal device.

It should be understood that, technical solutions of the fourth aspect of this application correspond to those of the first aspect to the third aspect of this application. Beneficial effects achieved by corresponding feasible embodiments implementations are similar. Details are not described again.

### BRIEF DESCRIPTION OF DRAWINGS

FIG. 1 is a diagram of an architecture of a communication system to which a communication device is applicable according to an embodiment of this application;

FIG. 2 is a diagram of a TDD working mode;

FIG. 3 is a diagram of an FDD working mode;

FIG. 4 is a diagram of a full-duplex working mode;

FIG. 5 is a diagram of a subband-duplex working mode;

FIG. 6 is a diagram of a partial full-duplex working mode;

FIG. 7 is a diagram of a self-interference canceller;

FIG. 8 is a diagram of an architecture of a base station of four transmit and four receive;

FIG. 9 is a diagram of using a self-interference canceller in the base station in FIG. 8;

FIG. 10 is a diagram of a radio frequency antenna link in a current AAU;

FIG. 11 is a diagram of an AAU according to an embodiment of this application;

FIG. 12 is a diagram of traces of feed networks according to an embodiment of this application;

FIG. 13 is a diagram of reducing interference by using different traces of feed networks according to an embodiment of this application;

FIG. 14 is top views of decoupling units according to an embodiment of this application;

FIG. 15 is a diagram of reducing interference through antenna decoupling surfaces;

FIG. 16 is a diagram of reducing interference by using an isolation unit made of a scattering material;

FIG. 17 is a diagram of an isolation unit located between antenna subarrays;

FIG. 18 is another diagram of an isolation unit located between antenna subarrays;

FIG. 19 is a diagram of isolation units located between antenna subarrays and between antenna elements;

FIG. 20 is another diagram of isolation units located between antenna subarrays and between antenna elements;

FIG. 21 is another diagram of isolation units located between antenna subarrays and between antenna elements;

FIG. 22 is another diagram of an isolation unit located between antenna subarrays;

FIG. 23 is another diagram of an AAU according to an embodiment of this application;

FIG. 24 is still another diagram of an AAU according to an embodiment of this application;

FIG. 25 is still another diagram of an AAU according to an embodiment of this application;

FIG. 26 is still another diagram of an AAU according to an embodiment of this application;

FIG. 27 is still another diagram of an AAU according to an embodiment of this application;

FIG. 28 is still another diagram of an AAU according to an embodiment of this application;

FIG. 29 is still another diagram of an AAU according to an embodiment of this application; and

FIG. 30 is still another diagram of an AAU according to an embodiment of this application.

### DETAILED DESCRIPTION

The following describes technical solutions of this application with reference to accompanying drawings.

For ease of understanding of embodiments of this application, the following several points are first provided.

First, for ease of description, terms such as “left”, “right”, “upper”, and “lower” that are used to describe orientations, and terms such as “horizontal” and “vertical” that are used to describe directions are introduced in this specification. It should be understood that these terms are introduced merely for ease of understanding described with reference to the accompanying drawings, and shall not constitute any limitation on this application. As a direction of an antenna panel changes, for example, tilting, turning over, or rotating, directions of antenna elements and antenna subarrays may change. However, this does not affect the antenna subarrays and a relative location relationship between the antenna elements. Second, in embodiments of this application, “at least one” means one or more, and “a plurality of” means two or more. “And/or” describes an association relationship between associated objects, and indicates that three relationships may exist. For example, A and/or B may indicate the following cases: Only A exists, both A and B exist, and only B exists, where A and B may be singular or plural. The character “/” usually indicates an “or” relationship between the associated objects, but does not exclude an “and” relationship between the associated objects. A specific indicated meaning may be understood with reference to the context. “At least one of the following items (pieces)” or a similar expression thereof indicates any combination of these items, including a single item (piece) or any combination of a plurality of items (pieces). For example, at least one of a, b, or c may indicate a, b, or c; a and b; a and c; b and c; or a, b, and c.

Third, in embodiments of this application, prefix words such as “first” and “second” are merely for ease of distinguishing between and describing different things belonging to a same name category, and are not intended to limit a sequence, sizes, or a quantity of things. For example, “first antenna subarray” and “second antenna subarray” are merely different antenna subarrays, and a quantity of antenna subarrays or a location of an antenna subarray is not limited.

Fourth, “sending” and “receiving” in embodiments of this application indicate directions of a signal in a communication device and an air interface. For example, “sending a downlink signal” means that the downlink signal arrives at an antenna element through a transmit channel, a filter, and the like, and then the downlink signal is radiated through the antenna element; and “receiving an uplink signal” means that after being received through an antenna element, an uplink signal passes through a filter, a receive channel, and the like, and arrives at another processing module in the communication device like a baseband chip.

Fifth, in embodiments of this application, unless otherwise explicitly specified and limited, terms “disposing”, “mounting”, “connection to”, and “connection” shall be understood in a broad sense, for example, may be a fixed connection, may be an indirect connection through an intermediate medium, may be an internal connection between two elements or an interaction relationship between two elements. A person of ordinary skill in the art may understand specific meanings of the foregoing terms in embodiments of this application based on specific cases.

Sixth, in embodiments of this application, for ease of understanding, a plurality of examples are provided. In some examples, an example in which a network device is a communication device for which the AAU provided in some embodiments of this application is configured is used for description. For the network device, a signal transmitted by the network device is a downlink signal, and a signal received by the network device is an uplink signal. In some other examples, the AAU may also be configured in a terminal device. Although no example is provided in this specification, a person skilled in the art may extend another example based on a same principle. For brevity, examples are not described one by one in this specification.

The technical solutions provided in this application may be applied to various communication systems, for example, a long term evolution (long term evolution, LTE) system, an LTE FDD system, an LTE TDD system, a sidelink (sidelink, SL) communication system, a worldwide interoperability for microwave access (worldwide interoperability for microwave access, WiMAX) communication system, a 5th generation (5th generation, 5G) mobile communication system or a new radio access technology (new radio access technology, NR), and a satellite communication system. The 5G mobile communication system may include non-standalone (non-standalone, NSA) networking and/or standalone (standalone, SA) networking.

The technical solutions provided in this application may be further applied to a future communication system, for example, a 6th generation (6th generation, 6G) mobile communication system, or a converged system of a plurality of systems. The technical solutions provided in this application may be further applied to device-to-device (device-to-device, D2D) communication, vehicle-to-everything (vehicle-to-everything, V2X) communication, machine-to-machine (machine-to-machine, M2M) communication, machine-type communication (machine-type communication, MTC), an internet of things (internet of things, IoT) communication system, or another communication system.

A device in a communication system may send a signal to another device or receive a signal from another device. The signal may include information, signaling, data, or the like. The device may alternatively be replaced with an entity, a network entity, a communication device, a communication module, a node, a communication node, or the like. In this application, the device is used as an example for description. For example, the communication system may include at least one terminal device and at least one network device. The network device may send a downlink signal to the terminal device, and/or the terminal device may send an uplink signal to the network device. It may be understood that the terminal device in this application may be replaced with a first device, the network device may be replaced with a second device, and the terminal device and the network device perform a corresponding communication method in this application.

The network device in this application may be a device that has a wireless transceiver function, and the network device may also be referred to as a radio access network (radio access network, RAN) device or an access network device. The network device may provide a wireless communication function service, and may access the terminal device to a wireless network.

The network device may be a base station. The base station may cover the following names in a broad sense, or may be replaced with the following names, for example, a NodeB (NodeB), an evolved NodeB (evolved NodeB, eNB), a next generation base station (next generation NodeB, gNB), a relay station, an access point, a transmission reception point (transmission reception point, TRP), a transmission point (transmission point, TP), a primary station, a secondary station, a multi-standard radio (motor slide retainer, MSR) node, a home base station, a network controller, an access node, a radio node, an access point (access point, AP), a transmission node, a transceiver node, a baseband unit (baseband unit, BBU), a remote radio unit (remote radio unit, RRU), an active antenna unit (active antenna unit, AAU), a radio head (remote radio head, RRH), a central unit (central unit, CU), a distributed unit (distributed unit, DU), a radio unit (radio unit, RU), or a positioning node. The base station may be a macro (macro) base station, a micro (micro) base station, a relay (relay) node, a donor node or the like, a combination thereof, a radio controller in a cloud radio access network (cloud radio access network, CRAN) scenario, a node in an open radio access network (open radio access network, O-RAN or ORAN) scenario, or the like. The base station may alternatively be a communication module, a modem, or a chip disposed in the foregoing device or apparatus. The base station may alternatively be a mobile switching center, a device that bears a base station function in D2D, V2X, and M2M communication, a network side device in a 6G network, a device that bears a base station function in a future communication system, or the like. The base station may support networks using a same access technology or different access technologies. In some embodiments, the RAN node may alternatively be a server, a wearable device, a vehicle, a vehicle-mounted device, or the like. For example, an access network device in a vehicle to everything (vehicle to everything, V2X) technology may be a road side unit (road side unit, RSU). A specific technology and a specific device form that are used by the network device are not limited in embodiments of this application. In some deployments, the network device mentioned in embodiments of this application may be a device including a CU or a DU, a device including a CU and a DU, or a device including a CU control plane node (a central unit-control plane (central unit-control plane, CU-CP)), a CU user plane node (a central unit-user plane (central unit-user plane, CU-UP)), and a DU node. For example, the network device may include a gNB-CU-CP, a gNB-CU-UP, and a gNB-DU.

In some deployments, a plurality of RAN nodes cooperate to assist the terminal in implementing radio access, and different RAN nodes separately implement a part of functions of the base station. For example, the RAN node may be a CU, a DU, a CU-CP, a CU-UP, or an RU. The CU and the DU may be separately disposed, or may be included in a same network element, for example, a BBU. The RU may be included in a radio frequency device or a radio frequency unit, for example, included in an RRU, an AAU, or an RRH.

The RAN node may support one or more types of fronthaul interfaces, and different fronthaul interfaces respectively correspond to DUs and RUs that have different functions. If a fronthaul interface between the DU and the RU is a common public radio interface (common public radio interface, CPRI), the DU is configured to implement one or more baseband functions, and the RU is configured to implement one or more radio frequency functions. If the fronthaul interface between the DU and the RU is another type of interface, in comparison with the CPRI, a part of downlink and/or uplink baseband functions, for example, for downlink, one or more of precoding (precoding), digital beamforming (beamforming, BF), or inverse fast Fourier transform (inverse fast Fourier transform, IFFT)/cyclic prefix (cyclic prefix, CP) addition are moved from the DU to the RU for implementation; and for uplink, one or more of digital beamforming (beamforming, BF) or fast Fourier transform (fast Fourier transform, FFT)/cyclic prefix (cyclic prefix, CP) removal are moved from the DU to the RU for implementation. In a possible implementation, the interface may be an enhanced common public radio interface (enhanced common public radio interface, eCPRI). In an eCPRI architecture, a split manner between the DU and RU are different, corresponding to different categories (categories, Cats) of eCPRIs, such as eCPRI Cats A, B, C, D, E, and F.

The eCPRI Cat A is used as an example. For downlink transmission, layer mapping is used as split. The DU is configured to implement the layer mapping and one or more previous functions (to be specific, one or more of coding, rate matching, scrambling, modulation, and layer mapping). Another function (for example, one or more of RE mapping, digital beamforming, or IFFT/CP addition) after the layer mapping is removed to the RU for implementation. For uplink transmission, RE demapping is used as split. The DU is configured to implement demapping and one or more previous functions (to be specific, one or more functions of decoding, rate de-matching, descrambling, demodulation, IDFT, channel equalization, and RE demapping). Another function (for example, one or more of digital BF or FFT/CP removal) after the demapping is removed to the RU for implementation. It may be understood that, for function descriptions of DUs and RUs corresponding to various categories of eCPRIs, refer to an eCPRI protocol. Details are not described herein.

In a possible design, a processing unit configured to implement a baseband function in the BBU is referred to as a base band high (base band high, BBH) unit, and a processing unit configured to implement a baseband function in the RRU/AAU/RRH is referred to as a base band low (base band low, BBL) unit.

In different systems, the CU (or the CU-CP and the CU-UP), the DU, or the RU may also have different names, but a person skilled in the art may understand meanings of the names. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. Any unit of the CU (or the CU-CP or the CU-UP), the DU, and the RU in this application may be implemented by using a software module, a hardware module, or a combination of a software module and a hardware module.

In embodiments of this application, an apparatus configured to implement a function of the network device may be a network device, or an apparatus that can support the network device in implementing the function, for example, a chip system, a hardware circuit, a software module, or a combination of a hardware circuit and a software module. The apparatus may be mounted in the network device or used together with the network device. In embodiments of this application, an example in which the apparatus configured to implement the function of the network device is a network device is merely used for description, and constitutes no limitation on the solutions in embodiments of this application.

The terminal device in this application may also be referred to as user equipment (user equipment, UE), an access terminal, a subscriber unit, a subscriber station, a mobile station, a remote station, a remote terminal, mobile equipment (mobile equipment, ME), a user terminal, a terminal, a wireless communication device, a user agent, or a user apparatus.

The terminal device may be a device that may provide voice/data connectivity, for example, a handheld device or a vehicle-mounted device that has a wireless connection function. Currently, some examples of the terminal device may be: a mobile phone (mobile phone), a tablet computer (pad), a computer (for example, a notebook computer or a palmtop computer) that has a wireless transceiver function, a mobile internet device (mobile internet device, MID), a virtual reality (virtual reality, VR) device, an augmented reality (augmented reality, AR) device, a wireless terminal in industrial control (industrial control), a wireless terminal in self driving (self driving), an uncrewed aerial vehicle, a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), a cellular phone, a cordless phone, a session initiation protocol (session initiation protocol, SIP) phone, a wireless local loop (wireless local loop, WLL) station, a personal digital assistant (personal digital assistant, PDA), a handheld device that has a wireless communication function, a compute device or another processing device connected to a wireless modem, a vehicle-mounted device, a wearable device, a terminal device in a 5G network, a terminal device in a future evolved public land mobile communication network (public land mobile network, PLMN), and the like.

The wearable device may also be referred to as a wearable intelligent device, and is a general term of wearable devices such as glasses, gloves, watches, clothes, and shoes, that are intelligently designed and developed for daily wear by using a wearable technology. The wearable device is a portable device that is directly worn on the body or integrated into clothes or an accessory of a user. The wearable device is not only a hardware device, but also implements a powerful function through software support, data exchange, and cloud interaction. In a broad sense, wearable intelligent devices include full-featured and large-sized devices that can implement complete or partial functions without depending on smartphones, such as smart watches or smart glasses, and devices that are dedicated to only one type of application function and need to work with other devices such as smartphones, such as various smart bands or smart jewelry for monitoring physical signs.

In addition, the terminal device may alternatively be a terminal device in the IoT system, or may be referred to as an IoT node. IoT is an important part of future information technology development. A main technical feature of the IoT is to connect an object to a network by using a communication technology, to implement an intelligent network for human-machine interconnection and thing-thing interconnection. The connection can be implemented through broadband or narrowband technologies. The IoT technology can achieve massive connections, deep coverage, and terminal power saving by using, for example, a narrow band (narrow band, NB) technology.

In addition, the terminal device may further include sensors such as an intelligent printer, a train detector, or a gas station. Main functions of the terminal device include collecting data (some terminal devices), receiving control information and downlink data from the network device, sending an electromagnetic wave, and transmitting uplink data to the network device.

The terminal device in this application may be a virtualized device, for example, implemented by using general-purpose hardware and an instantiated virtualization function, or by using dedicated hardware and an instantiated virtualization function. The general-purpose hardware may be a server, for example, a cloud server.

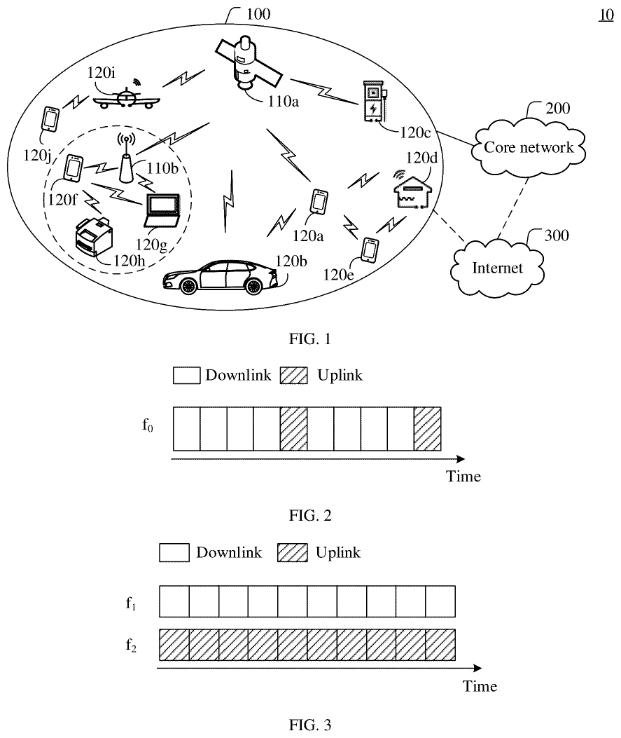

FIG. 1 is a diagram of an architecture of a communication system 10 to which a communication device is applicable according to an embodiment of this application. As shown in FIG. 1, the communication system 10 includes a radio access network 100 and a core network 200. In some embodiments, the communication system 10 further includes an internet 300. The radio access network 100 may include at least one radio access network device (for example, 110a and 110b in FIG. 1), and may further include at least one terminal device (for example, 120a to 120j in FIG. 1). The terminal device may be connected to the radio access network device in a wireless manner. Terminal devices may be connected to each other in a wired or wireless manner, so are radio access network devices. FIG. 1 is merely a diagram. The communication system 10 may further include another network device, for example, may further include a wireless relay device and a wireless backhaul device, which are not shown in FIG. 1.

The radio access network device may be a base station deployed in the air, for example, may be a satellite base station 110a; or may be a base station deployed indoors, for example, may be a micro base station or an indoor base station 110b. It should be understood that a specific technology and a specific device form that are specifically used by the radio access network device are not limited in this application. For ease of description, the following provides descriptions by using an example in which the base station is used as the radio access network device.

The terminal device may be a terminal device deployed in the air, for example, a helicopter 120i or an uncrewed aerial vehicle 120i in FIG. 1; or may be a terminal device deployed on the ground, for example, mobile phones 120a, 120e, 120f, and 120j, a vehicle 120b, a computer 110b, and a printer 120h in FIG. 1.

The base station and the terminal may be fixed or movable. The base station and the terminal may be deployed on the land, including an indoor device, an outdoor device, a handheld device, or a vehicle-mounted device; may be deployed on the water; or may be deployed on an airplane, a balloon, and an artificial satellite in the air. Application scenarios of the base station and the terminal are not limited in embodiments of this application.

Communication between the base station and the terminal, between base stations or between the terminal and the terminal may be performed by using a licensed spectrum, may be performed by using an unlicensed spectrum, or may be performed by using both the licensed spectrum and the unlicensed spectrum. Communication may be performed by using a spectrum below 6 gigahertz (gigahertz, GHz), may be performed by using a spectrum above 6 GHz, or may be simultaneously performed by using the spectrum below 6 GHz and the spectrum above 6 GHz. A spectrum resource used for wireless communication is not limited in embodiments of this application.

A current communication system has a plurality of working modes such as TDD, FDD, full duplex, subband duplex, and partial full duplex. The following briefly describes the foregoing several working modes with reference to accompanying drawings.

FIG. 2 is a diagram of a TDD working mode. As shown in the figure, in the TDD working mode, a network device receives signals and sends signals on entire frequency bandwidth of f₀. For example, the network device may send a downlink signal in a downlink slot shown in a blank block in FIG. 2, and receive an uplink signal in an uplink slot shown in a block with a filling pattern [symbol] . Correspondingly, a terminal device receives the downlink signal in the downlink slot, and sends the uplink signal in the uplink slot. It should be understood that a ratio of the uplink slot to the downlink slot shown in FIG. 2 is 1:4, and this is merely a possible ratio of the uplink slot to the downlink slot. TDD may alternatively have another slot ratio. This is not limited in this application.

FIG. 3 is a diagram of an FDD working mode. As shown in the figure, in the FDD working mode, a network device sends downlink signals in all slots (as shown in blank blocks in FIG. 3) on frequency bandwidth of f₁, and receives uplink signals in all slots (as shown in blocks with filling patterns [symbol] in FIG. 3) on frequency bandwidth of f₂. Correspondingly, a terminal device receives the downlink signals in all the slots on the frequency bandwidth of f1, and sends the uplink signals in all the slots on the frequency bandwidth of f₂. f₁ may be referred to as downlink frequency, and f₂ may be referred to as uplink frequency.

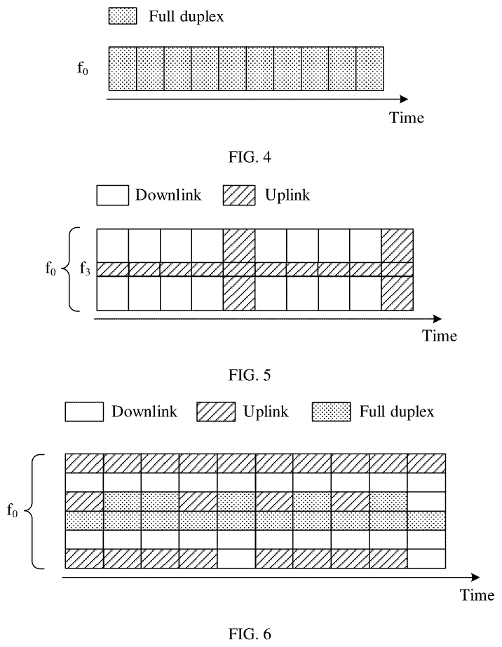

FIG. 4 is a diagram of a full-duplex working mode. A network device simultaneously sends a downlink signal and receives an uplink signal in all slots (as shown in blocks with filling patterns [symbol] in FIG. 4) on entire frequency bandwidth of f₀. Correspondingly, a terminal device simultaneously receives the downlink signal and sends the uplink signal in all the slots on the entire frequency bandwidth of f₀. In the full-duplex working mode, a frequency resource may be repeatedly used, thereby improving frequency efficiency. However, because the network device sends a signal and receives a signal on a same time-frequency resource, there is severe interference.

FIG. 5 is a diagram of a subband-duplex working mode. The subband-duplex working mode may be considered as a variant of the TDD working mode. In the subband-duplex working mode, all slots on a small part of frequency bandwidth of f₀: frequency bandwidth of f₃, are uplink slots. As shown in blocks with filling patterns [symbol] corresponding to frequency f₃ in FIG. 5, a network device may receive uplink signals in all the slots on the frequency bandwidth of f₃, and a terminal device may send the uplink signals in all the slots on the frequency bandwidth of f₃. A part of the frequency bandwidth of f₀ other than the frequency bandwidth of f₃ is still divided into an uplink slot and a downlink slot based on the TDD working mode. For example, the network device may send downlink signals in downlink slots shown in blank blocks in FIG. 5, and receive uplink signals in uplink slots shown in blocks with filling patterns [symbol] . Correspondingly, the terminal device receives the downlink signal in the downlink slots, and sends the uplink signals in the uplink slots.

The subband-duplex working mode can improve uplink coverage and enhance a signal-to-noise ratio of the uplink signal, that is, enhance a signal-to-noise ratio of a signal sent by the terminal device to the network device. However, similar to the full-duplex working mode shown in FIG. 4, the network device may send a signal and receive a signal on a same time-frequency resource, and there is severe interference. Although frequency of receiving a signal is different from frequency of sending a signal, the downlink signal is also coupled to a receive channel. In addition, due to high transmit power of the downlink signal, the receive channel is blocked, degrading performance of the receive channel.

FIG. 6 is a diagram of a partial full-duplex working mode. A partial full-duplex time-frequency resource is a combination of several working modes: subband duplex, full duplex, and TDD. As shown in the figure, in frequency bandwidth of f₀, slots on a part of the frequency bandwidth are divided into uplink slots and downlink slots based on the TDD, as shown in a 1^{st}row and a 6^{th} row in time-frequency resources from top to bottom in FIG. 6; all slots on a part of the frequency bandwidth are uplink slots, as shown in a 2^{nd} row and a 5^{th} row in time-frequency resources from top to bottom in FIG. 6; all slots on a part of the frequency bandwidth are full-duplex slots, as shown in a 4^{th} row in time-frequency resources from top to bottom in FIG. 6; and slots on a part of the frequency bandwidth are switched between a downlink slot, an uplink slot, and a full-duplex slot with time, as shown in a 3^{rd} row in time-frequency resources from top to bottom FIG. 6.

It should be noted that any receiver has a specific receiving dynamic range. When receive power exceeds maximum power allowed for the receiving dynamic range, a non-linear device of the receiver is saturated, and non-linear distortion is generated, causing multi-order products of intermodulation and crossmodulation. This is receiver blocking, which causes the receiver to fail to work normally. The receiver blocking may also occur on a receive channel, that is, the receive channel is blocked. Correspondingly, such interference is referred to as blocking interference.

In some working modes, for example, the full duplex, the subband duplex, and the partial full duplex, a network device may simultaneously transmit a signal and receive a signal by using a same group or a plurality of groups of antenna units, that is, using an antenna for both reception and transmission. Using the antenna for both reception and transmission means that the same group or the plurality of groups of antenna units are used for both reception and transmission, where one group of antenna units may include one or more antenna units. When the antenna is for both reception and transmission, the receive channel may be blocked. To avoid blocking of the receive channel, a self-interference canceller is usually used to reduce interference of a downlink signal received on the receive channel. The self-interference canceller aims to construct a radio frequency signal with a same amplitude and opposite phase as an interference signal, and synthesize the radio frequency signal with the interference signal, to achieve a cancellation effect on the interference signal. FIG. 7 is an example of a self-interference canceller. As shown in FIG. 7, the self-interference canceller may include a plurality of links, and each tap link includes elements such as an adjustable phase shifter and an adjustable attenuator. Consequently, circuit complexity is high.

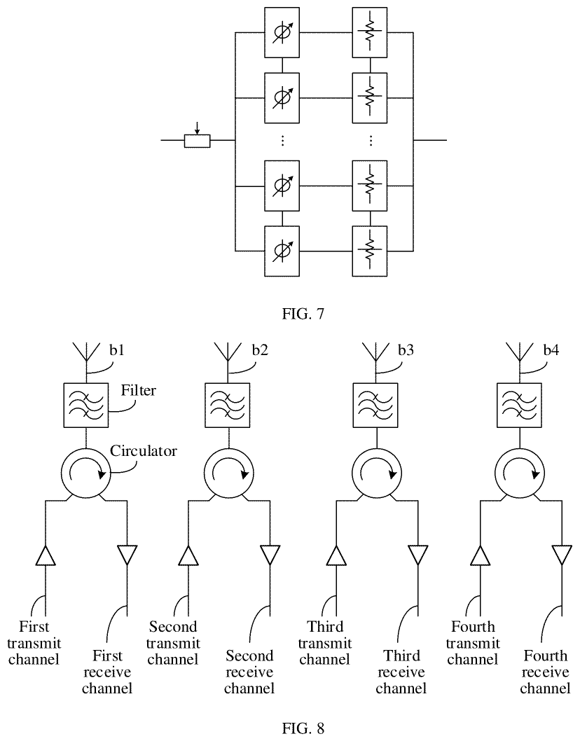

Currently, a common architecture of a base station whose antenna is for both reception and transmission includes one transmit and one receive, two transmit and two receive, four transmit and four receive, and the like. The four transmit and four receive is used as an example. While transmitting signals by using four groups of antenna units, the base station may use the four groups of antenna units to receive signals. FIG. 8 is a diagram of an architecture of a base station of four transmit and four receive. FIG. 8 shows four radio frequency antenna links from left to right. Each radio frequency antenna link includes a transmit channel, a receive channel, an antenna shared by the transmit channel and the receive channel, and a filter and a circulator that are connected between the transmit channel, the receive channel, and the antenna. In a sequence from left to right, four antenna subarrays are respectively denoted as an antenna b1, an antenna b2, an antenna b3, and an antenna b4. Four transmit channels are sequentially denoted as a first transmit channel, a second transmit channel, a third transmit channel, and a fourth transmit channel. Four receive channels are sequentially denoted as a first receive channel, a second receive channel, a third receive channel, and a fourth receive channel. The four radio frequency antenna links are sequentially denoted as a first radio frequency antenna link, a second radio frequency antenna link, a third radio frequency antenna link, and a fourth radio frequency antenna link.

The first radio frequency antenna link is used as an example. Due to isolation limitation of a circulator, some components (for example, denoted as a1) of a downlink signal transmitted on the first transmit channel is coupled to the first receive channel through the circulator on the link; some components (for example, denoted as a2) are reflected from an input port of a filter on the link, then enter the circulator, and subsequently enter the first receive channel; some components (for example, denoted as a3) are reflected from an input port of the antenna b1, then enter the filter and the circulator, and subsequently enter the first receive channel. In addition, some components of downlink signals, for example, a component (for example, denoted as a4) of a downlink signal transmitted on the second transmit channel, a component (for example, denoted as a5) of a downlink signal transmitted on the third transmit channel, and a component (for example, denoted as a6) of a downlink signal transmitted on the fourth transmit channel, are respectively coupled to the antenna b1 through the connected antennas b2, b3, and b4, and then enter the first receive channel through the filter and the circulator in the first radio frequency antenna link. Because the components a1 to a6 of the downlink signals still have high power when entering the first receive channel, the first receive channel is blocked, affecting receive performance. The rest can be deduced by analogy. The second receive channel, the third receive channel, and the fourth receive channel respectively receive components of similar downlink signals, causing blocking of the receive channels and affecting receive performance.

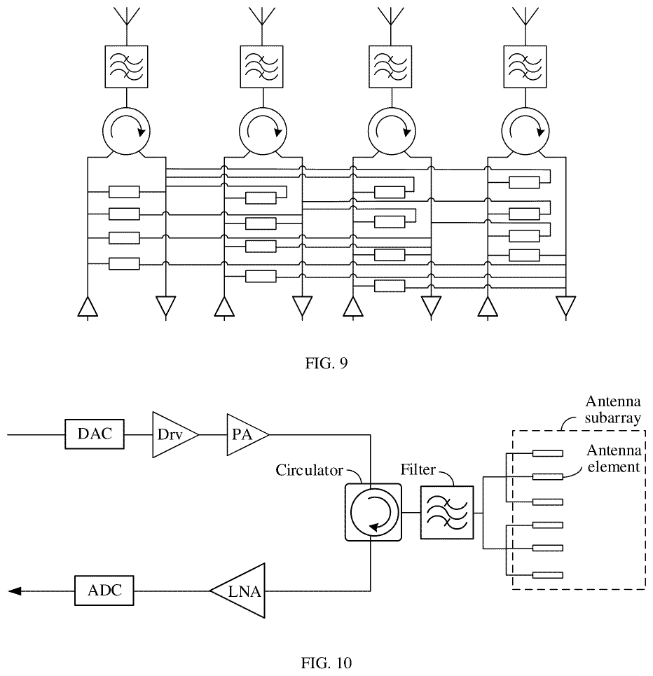

If the foregoing self-interference canceller is used to suppress the blocking of the receive channels, the self-interference canceller needs to be used between each receive channel and each transmit channel to reduce interference. FIG. 9 shows an example of using the self-interference canceller in the architecture of the base station shown in FIG. 8. As shown in FIG. 9, a self-interference canceller is connected between the first transmit channel and each of the first receive channel, the second receive channel, the third receive channel, and the fourth receive channel; a self-interference canceller is also connected between the second transmit channel and each of the first receive channel, the second receive channel, the third receive channel, and the fourth receive channel; a self-interference canceller is also connected between the third transmit channel and each of the first receive channel, the second receive channel, the third receive channel, and the fourth receive channel; and a self-interference canceller is also connected between the fourth transmit channel and each of the first receive channel, the second receive channel, the third receive channel, and the fourth receive channel. In conclusion, to avoid blocking of the receive channels, the base station uses 16 self-interference cancellers in total, to form a 4×4 fully-connected network.

As a quantity of antenna units for both reception and transmission increases, a value of N tends to increase, leading to a sharp increase in a quantity of self-interference cancellers and a significant rise in circuit complexity.

In view of this, this application provides an AAU. An isolation technology is used between different radio frequency antenna links, and a plurality of solutions are provided for the isolation technology. For example, a feed network is optimized and designed, so that amplitudes and/or phases of signals on different links are different, to reduce near-field energy of a receive antenna. For another example, an antenna decoupling surface (antenna decoupling surface, ADS) is used above antenna subarrays to reduce signal interference between the antenna subarrays. For still another example, an isolation unit like a wave-absorbing material, a scattering material, or a metamaterial is used for a signal between adjacent antenna subarrays to reduce signal interference between the antenna subarrays. A self-interference canceller may still be used between a transmit channel and a receive channel of a same radio frequency antenna link to cancel signal interference in the link. In this way, in addition to using the self-interference canceller on the link to cancel interference, the interference between different links may be canceled in another manner, so that a quantity of self-interference cancellers is greatly reduced, thereby significantly reducing complexity.

For ease of understanding and description, before embodiments of this application are described, terms used in this specification are first briefly described.
1. AAU: The AAU is a main device of a 5G base station, and is an implementation solution of a large-scale antenna array. The AAU can be considered as a combination of a remote radio unit (remote radio unit, RRU) and an antenna.
2. Antenna subarray: In this application, to distinguish between antenna elements connected to different radio frequency channels (including a transmit channel and a receive channel), antenna elements connected to a same radio frequency channel are defined as one antenna subarray. A same antenna subarray is connected to a same radio frequency channel, and different antenna subarrays are connected to different radio frequency channels.
3. Antenna element: The antenna element is also referred to as an element or a radiating element, and is a most basic unit of an antenna. The antenna element is made of conductive metal. When an alternating current flows on a conductor, electromagnetic wave radiation may occur. Therefore, the antenna element may also be referred to as a radiator, the radiating element, or the like.
4. Feed network: The feed network may also be referred to as a power allocation unit. In this application, the feed network is configured to feed power to a connected antenna subarray (which may be specifically an antenna element in the antenna subarray). The feed network may feed a radio frequency signal to the antenna subarray based on a specific amplitude and a specific phase, or send a radio signal received by the antenna subarray to a signal processing unit in a communication device based on a specific amplitude and a specific phase.
5. Antenna: The antenna includes a reflection plate (also referred to as a bottom plate), a feed network, and an antenna element. In some embodiments, the antenna further includes a radome. For ease of understanding and description, this specification mainly shows the antenna element, the feed network, and a radio frequency channel connected to the feed network with reference to accompanying drawings, and does not show other parts such as the reflection plate and the radome. However, this shall not constitute any limitation on this application. A structure of the antenna and a form of the antenna element are not limited in this application.

It should be understood that, for a specific structure and a working principle of the antenna, refer to an existing technology. Details are not described in this application.

The following describes the technical solutions of this application in detail with reference to the accompanying drawings.

For ease of understanding, information about a current radio frequency antenna link is first described with reference to FIG. 10.

FIG. 10 is a diagram of a radio frequency antenna link in a current AAU. As shown in FIG. 10, each radio frequency antenna link includes: an antenna subarray, a feed network, a filter (filter), a circulator (circulator), a transmit channel, and a receive channel in a sequence from the antenna subarray. The transmit channel and the receive channel are connected to the circulator, the circulator is connected to the filter, and the filter is connected to the antenna subarray through the feed network. The circulator is also referred to as a circulator, and is a multi-port device configured to transmit an electromagnetic wave entering any port to a next port in a direction sequence determined by a static bias magnetic field, and can transmit high-frequency signal energy unidirectionally. In the AAU, the circulator may transmit a signal (for example, a downlink signal) from the transmit channel to the filter, or may transmit a signal (for example, an uplink signal) from the filter to the receive channel. The filter may be configured to effectively filter out a frequency point of a specific frequency or a frequency other than the frequency point in a power cable, to obtain a power signal of the specific frequency, or cancel a power signal of the specific frequency. In the AAU, the filter may filter out, to some extent, noise of signals that pass through. The feed network may feed the antenna subarray by using a radio frequency line. The radio frequency line includes a strip line or microstrip line for feeding. Through designing of the radio frequency line, for example, designing of the width and/or the length, the feed network can feed the signal from the transmit channel to the antenna subarray based on a specific phase and a specific amplitude, or feed a signal from the antenna subarray to the filter based on a specific phase and a specific amplitude.

The antenna subarray includes one or more antenna elements, and the one or more antenna elements are arranged according to a specific rule to form one subarray. The antenna subarray shown in the figure includes six antenna elements. The six antenna elements are connected to a same filter through the feed network, as shown in the figure. Therefore, this may be referred to as one-drive-six.

It should be understood that a quantity relationship between the filter and the antenna element in the figure is merely an example. In actual application, one filter may be connected to more or fewer antenna elements, for example, one-drive-three, one-drive-four, or one-drive-nine. A plurality of antenna elements may also be divided into more groups. For example, nine antenna elements are divided into three groups, and are connected to the filter. This is not limited in this application.

Further, as shown in the figure, the transmit channel includes: a power amplifier (power amplifier, PA), a radio frequency driver (Driver, Drv) amplifier (shown as Drv in the figure), a digital-to-analog converter (digital-to-analog converter, DAC), and the like. The DAC is configured to convert a to-be-transmitted digital signal on the transmit channel into an analog signal, and the PA is configured to perform power amplification on the signal.

The receive channel includes an LNA, an ADC, and the like. The LNA is configured to cancel noise, and the ADC is configured to convert a received digital signal into an analog signal.

It should be understood that the devices included in the radio frequency antenna link shown in FIG. 10 are merely examples. The radio frequency antenna link may further include another device, or one or more devices in FIG. 10 are replaced with another device that may be used to implement a same or similar function. This is not limited in this application.

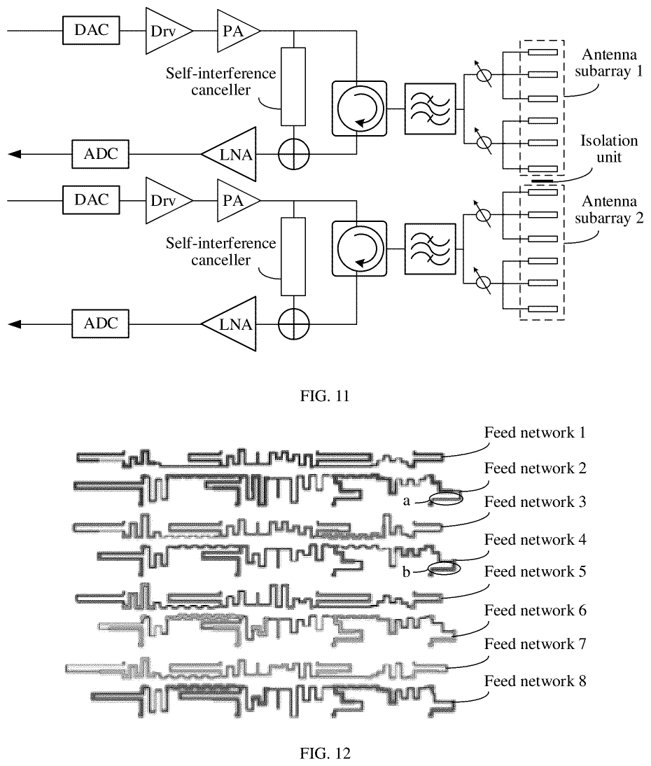

It should be noted that, in radio frequency antenna links shown in FIG. 10 and the following FIG. 11 and FIG. 23 to FIG. 30, each antenna subarray is connected to one radio frequency channel, and each antenna subarray may be driven by the connected radio frequency channel. For brevity below, details are not repeated for description.

FIG. 11 is a diagram of an AAU according to an embodiment of this application. As shown in FIG. 11, the AAU includes N (N is an integer greater than 1) radio frequency antenna links. Each radio frequency antenna link includes one antenna subarray. In other words, the N radio frequency antenna links include N antenna subarrays. The N radio frequency antenna links are in one-to-one correspondence with the N antenna subarrays. It is easy to learn that the devices included in the radio frequency antenna link in FIG. 10 also exist in FIG. 11. For the same devices, refer to the related descriptions in FIG. 10. Details are not described again.

FIG. 11 shows an example in which N is 2. As shown in the figure, two antenna subarrays of the two radio frequency antenna links are respectively shown as an antenna subarray 1 and an antenna subarray 2 in the figure. Different traces are designed for feed networks in the two radio frequency antenna links, and/or an isolation assembly is disposed between the antenna subarrays, so that interference between the antenna subarrays can be reduced.

That traces of feed networks of different radio frequency antenna links are different may specifically mean that layouts of radio frequency lines in PCBs of different radio frequency antenna links are different. That the layouts of the radio frequency lines are different may include:
Lengths of the radio frequency lines are different, and/or widths of the radio frequency lines are different. By way of example but not limitation, the radio frequency line includes a microstrip line or strip line. For ease of description, in this specification, a design solution in which the traces of the feed networks of the different radio frequency antenna links are different is denoted as Solution 1.

For ease of understanding, FIG. 12 shows feed networks in different radio frequency antenna links. The feed networks shown in FIG. 12 are traces of feed networks in eight radio frequency antenna links. Each radio frequency antenna link corresponds to one horizontal trace in the figure, and the eight radio frequency antenna links correspond to eight horizontal traces in the figure.

The eight traces shown in FIG. 12 are slightly different. As shown at a of a feed network 2 and b of a feed network 4 in FIG. 12, a line length shown at b is greater than a line length shown at a, indicating that a length of a radio frequency line of the feed network 2 is different from a length of a radio frequency line of the feed network 4 at the location. A line shown at b is also thicker than the line shown at b, indicating that a width of the radio frequency line of the feed network 2 is also different from a width of the radio frequency line of the feed network 4 at the location. It is easy to find through careful observation that traces of eight radio frequency lines shown in FIG. 12 are not completely the same. Through different routing designs, phases of signals transmitted on the eight radio frequency antenna links are different, and the signals tend to have opposite phases and achieve energy cancellation in a near field.

For ease of description, an example in which the AAU is configured for a network device is used in the following for description. For a downlink signal transmitted by an antenna subarray, another antenna subarray near the antenna subarray may be considered as a receiver. Therefore, a plurality of antenna subarrays are named as a sender antenna subarray and a receiver antenna subarray in the following descriptions for distinguishing. It may be understood that each antenna subarray may be the sender antenna subarray, or may be the receiver antenna subarray. Sending or receiving is relative to a signal.

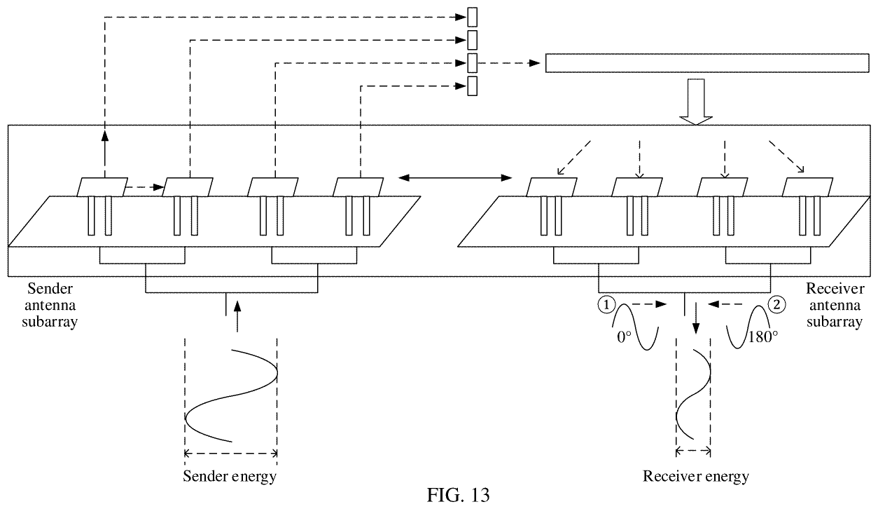

FIG. 13 is a diagram of reducing interference by using different traces of feed networks. In FIG. 13, a trace of a feed network of a sender antenna subarray is different from a trace of a feed network of a receiver antenna subarray. Through different routing designs of feed networks in different radio frequency antenna links, in an aspect, when the sender antenna subarray transmits a downlink signal, downlink signals received by different antenna elements of the receiver antenna subarray at a near field of the sender antenna subarray have opposite phases and undergo vector cancellation and energy reduction. Therefore, energy and interference of the downlink signals received by the receiver antenna subarray are reduced, but the downlink signals received by a far-field antenna (for example, a terminal antenna) have same phases and superimposed energy. In another aspect, through the design of the feed network of the receiver antenna subarray, after each antenna element in the receiver antenna subarray receives the downlink signal, vector cancellation may further occur in a circuit domain. For example, in FIG. 13, downlink signals \textcircled{1} and \textcircled{2} with opposite phases are received by different antenna elements, so that energy of the downlink signals is further reduced, and interference is further reduced.

It should be understood that the feed networks in the eight radio frequency antenna links shown in FIG. 12 are merely examples. In an actual design, a person skilled in the art may continuously optimize routing of a feed network through a plurality of tests, to achieve the objectives described in the foregoing two aspects. Therefore, there may alternatively be a case in which the feed networks of the eight radio frequency links are partially different. In other words, when N is greater than 2, traces of feed networks of at least two of the N radio frequency antenna links are different.

In addition to different routing designs of the feed networks, some embodiments of this solution further provides a solution of disposing an isolation assembly, to reduce interference between antenna subarrays.

A design of the isolation assembly is an antenna decoupling surface (ADS). In some embodiments, the isolation assembly includes M decoupling units located above N antenna subarrays. The quantity M of the decoupling units may be a multiple of the quantity N of the antenna subarrays. For example, M=N, or M=αN, where α is a non-zero coefficient. The M decoupling units may be evenly arranged and cover above an antenna element. The M decoupling units are combined together to form an antenna decoupling surface. The antenna decoupling surface may reflect a part of a received signal, to reduce interference. For ease of description, in this specification, a design solution in which antenna decoupling surfaces are disposed above the N antenna subarrays is denoted as Solution 2.

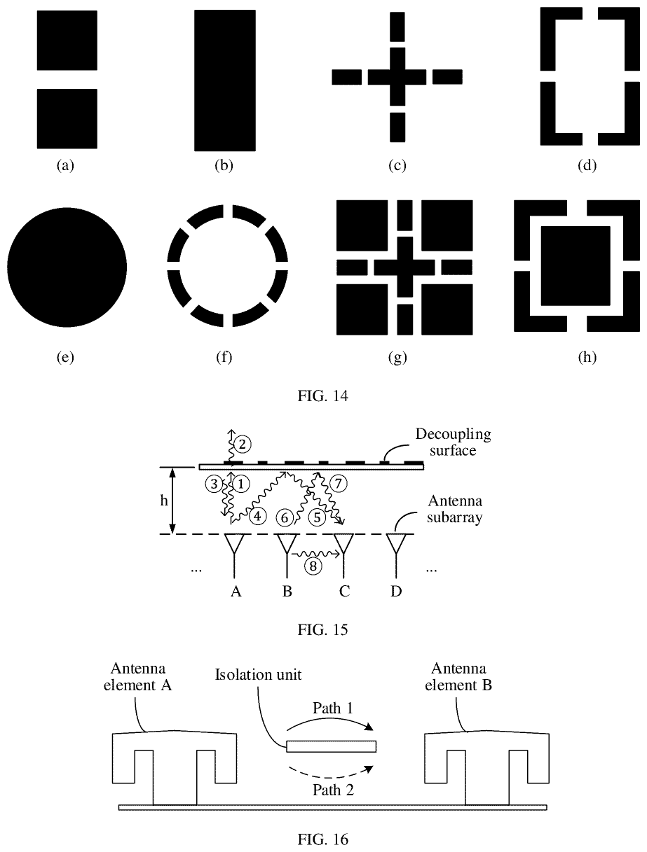

FIG. 14 is top views of decoupling units. (a) to (h) in FIG. 14 show the decoupling units in different shapes. However, it should be understood that FIG. 14 is merely an example, and a shape of the decoupling unit is not limited in this application. In embodiments of this application, the M decoupling units above the N antenna subarrays may be decoupling units in a same shape.

FIG. 15 is a diagram of reducing interference through antenna decoupling surfaces. FIG. 15 shows antenna subarrays A, B, C, and D. For ease of understanding and description, this specification describes a function of the decoupling surface by using interference of the antenna subarrays A and B on the antenna subarray C as an example. When the antenna subarray A transmits a signal, the transmitted signal may be propagated in different directions, for example, including but not limited to paths \textcircled{1} and \textcircled{4} shown in the figure. A part of the signal propagated along the path \textcircled{1}may continue to propagate outwards through the decoupling surface, as shown in a path \textcircled{2} in the figure, and the other part returns to the antenna subarray A along a path \textcircled{3} after being reflected by the decoupling surface. After arriving at the decoupling surface, the signal transmitted along the path \textcircled{4} may be reflected by the decoupling surface, and arrives at the antenna subarray C along a path \textcircled{5}, causing interference on a receive channel of the antenna subarray C. In addition, a signal transmitted by the antenna subarray B may also be propagated in different directions, for example, including but not limited to paths 6 and 8 shown in the figure. After arriving at the decoupling surface, the signal propagated along the path 6 may be reflected by the decoupling surface, and arrives at the antenna subarray C along a path 7, causing interference on a receive channel of the antenna subarray C. The signal propagated along the path 8 may also arrive at the antenna subarray C, for example, may be directly coupled or transmitted to the receive channel of the antenna subarray C, causing interference on the receive channel of the antenna subarray C.

In addition, the antenna subarray D in FIG. 15 and another antenna subarray that is not shown in FIG. 15 may also cause interference on the antenna subarray C.

Because phases of interference signals arriving at the antenna subarray C along different paths are likely to be different, a relative location of the decoupling surface and the antenna subarray is designed, so that energy of these interference signals can be reduced based on a principle of opposite phases and energy cancellation, thereby reducing the interference on the receive channel of the antenna subarray C. In a possible design, a spacing (h shown in FIG. 15) between the decoupling surface and an upper surface of the antenna subarray is one quarter of a wavelength of an electromagnetic wave signal.

It may be understood that, in the example in FIG. 15, an interference signal between three antenna subarrays is merely used as an example to describe a function of the decoupling surface. In actual application, the antenna subarray C may be interfered by signals transmitted by more antenna subarrays. In addition, each antenna subarray in an antenna array, like the antenna subarray C in FIG. 15, may also be interfered by signals transmitted by one or more other antenna subarrays around the antenna subarray. Therefore, the decoupling surface may also be used in a larger range, for example, used above the N antenna subarrays in some embodiments of this solution, to reduce interference between different antenna subarrays. For example, a decoupling surface located above an antenna subarray (denoted as a first antenna subarray) in the N antenna subarrays may reflect a part of a signal of another antenna subarray, to cancel a signal that is from the another antenna subarray and that is on a receive channel connected to the first antenna subarray.

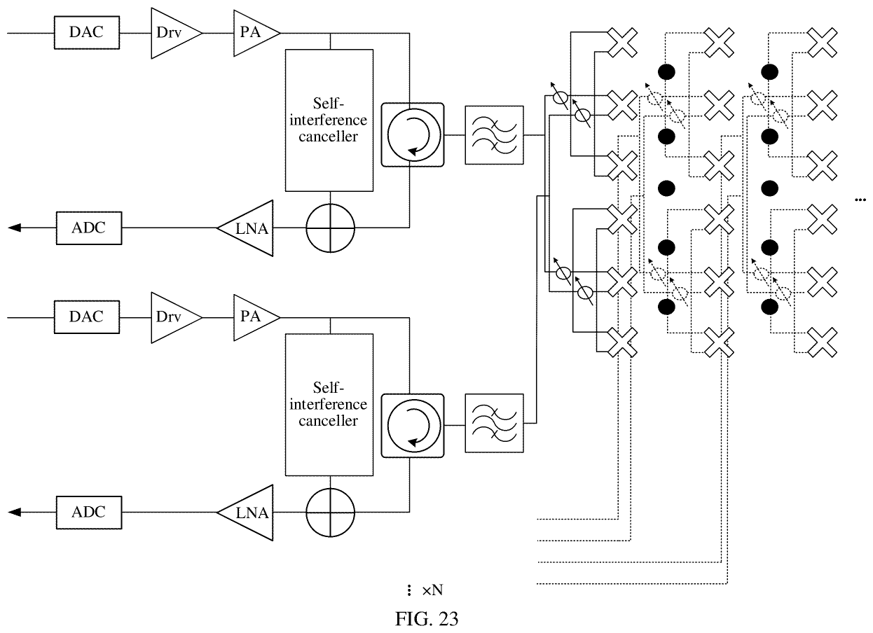

It should be noted that, because the antenna decoupling surface is located above the antenna subarray, FIG. 11 and the following FIG. 23 are not shown due to inconvenience of illustration. However, this shall not constitute any limitation on this application.

Another design of the isolation assembly is to dispose an isolation unit between the antenna subarrays that is made of a wave-absorbing material, a scattering material, or a metamaterial. For ease of description, in this specification, a design solution in which the isolation unit is disposed between the N antenna subarrays is denoted as Solution 3.

The wave-absorbing material may absorb or weaken electromagnetic wave energy received on a surface of the wave-absorbing material. Therefore, the wave-absorbing material can be used to make the isolation unit. Both the scattering material and the metamaterial can be used to control amplitudes and phases of electromagnetic waves and change scattering paths or reflection paths of the electromagnetic waves, to achieve an effect of canceling downlink signals, and therefore can be used to make the isolation unit.

In this application, each isolation unit may be made of one of the wave-absorbing material, the scattering material, and the metamaterial. When the isolation assembly includes a plurality of isolation units, different isolation units may be made of a same material, for example, one of the wave-absorbing material, the scattering material, and the metamaterial; or different isolation units may be made of different materials, for example, any two or three of the wave-absorbing material, the scattering material, and the metamaterial.

In an example, FIG. 16 is a diagram of reducing interference by using an isolation unit made of a scattering material. FIG. 16 shows the isolation unit located between two antenna elements A and B. The isolation unit is located near a midpoint between the two antenna elements, and is placed parallel to a reflection plate. Because the isolation unit is made of the scattering material, a signal from the antenna element A undergoes scattering of the isolation unit, so that some components of a signal that is originally propagated through a path 1 are propagated through a path 2, and the signal components of the path 1 and signal components of the path 2 have equal amplitudes and opposite phases. In this way, the signal may be canceled, thereby reducing interference on the antenna element B.

It should be understood that FIG. 16 is merely an example, and a quantity of isolation units and a location of the isolation unit are not limited in this application.

In some embodiments, the isolation assembly includes at least one isolation unit located between adjacent antenna subarrays in N antenna subarrays, and the at least one isolation unit is configured to isolate an interference signal between at least some of the N antenna subarrays.

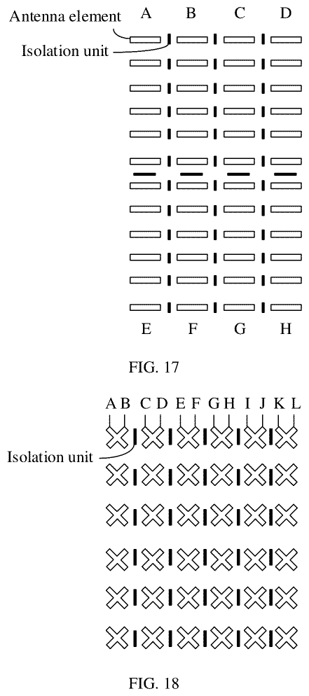

FIG. 17 is a diagram of an isolation unit located between antenna subarrays. FIG. 17 shows eight antenna subarrays, respectively shown by hollow blocks identified by A, B, C, D, E, F, G and H in the figure. An isolation unit is disposed between every two adjacent antenna subarrays, as shown by a solid block in the figure. It can be learned that the isolation unit is located between adjacent antenna subarrays. For example, in the figure, at a junction between the antenna subarray A and the antenna subarray B, at a junction between the antenna subarray B and the antenna subarray C, or the like, one isolation unit is disposed between every two adjacent antenna elements (it should be understood that the two antenna elements are antenna elements in different subarrays) in a horizontal direction. For another example, in the figure, at a junction between the antenna subarray A and the antenna subarray E, or at a junction between the antenna subarray B and the antenna subarray F, one isolation unit is also disposed between every two adjacent antenna elements (it should be understood that the two antenna elements are antenna elements in different subarrays) in a vertical direction.

Therefore, these isolation units may be configured to isolate an interference signal between different antenna subarrays, for example, an interference signal between the antenna subarray A and the antenna subarray B, an interference signal between the antenna subarray A and the antenna subarray C, an interference signal between the antenna subarray A and the antenna subarray E, and so on. The rest can be deduced by analogy, and is not enumerated.

It should be understood that the antenna element is not limited to being used in the antenna shown in FIG. 17. The antenna element may alternatively be an antenna element in a dual-polarized antenna, or an antenna element in an antenna of another form.

FIG. 18 is another diagram of an isolation unit located between antenna subarrays. FIG. 18 shows antenna elements in a dual-polarized antenna with six rows and six columns. Each column of antenna elements in a same polarization direction belongs to one subarray, and each column includes two subarrays in different polarization directions. FIG. 17 shows 12 antenna subarrays in total, respectively as shown by A, B, C, D, E, F, G, H, I, J, K and L in the figure.

It should be noted that the dual-polarized antenna may also be referred to as a cross-polarized antenna. The dual-polarized antenna includes two antenna elements in different polarization directions. Each dual-polarized antenna may be cross-connected, and two antenna elements distributed (or placed) in a cross-connected manner may form ±45°dual-polarized radiation. A polarization direction of one antenna subarray is +45°, and a polarization direction of the other antenna subarray is −45°; or a polarization direction of one antenna subarray is a horizontal polarization direction, and a polarization direction of the other antenna subarray is a vertical polarization direction. This is not limited in this application. Because antenna elements in the two antenna subarrays are used to form a dual-polarized antenna, there is a limitation on disposing an isolation unit between the two antenna subarrays that form the dual-polarized antenna. However, interference between the antenna subarrays may be reduced by designing different traces for feed networks in two radio frequency links, and/or disposing decoupling units above the antenna subarrays.

In this embodiment, for ease of description and differentiation, the two subarrays that form the dual-polarized antenna subarray are denoted as one group of antenna subarrays. FIG. 17 shows six groups of antenna subarrays in total. Isolation units are disposed between the groups. These isolation units may be located between two adjacent groups of antenna subarrays, and specifically, may be located between two adjacent groups of antenna elements in a horizontal direction, as shown by solid blocks in the figure. These isolation units may be configured to isolate interference signals between different groups of antenna subarrays, for example, interference signals between antenna subarrays A and B and antenna subarrays C and D, interference signals between antenna subarrays A and B and antenna subarrays E and F, and interference signals between antenna subarrays C and D and antenna subarrays E and F, and so on. The rest can be deduced by analogy, and is not enumerated.

It may be understood that, when an antenna in an AAU is a dual-polarized antenna, N is an even number.

Further, the isolation assembly further includes: at least one isolation unit located between adjacent antenna elements, where the at least one isolation unit is configured to isolate an interference signal between the antenna elements. For ease of description, in this specification, a design solution in which the isolation unit is disposed between the antenna elements may be considered as an optional solution provided based on Solution 3.

In other words, the isolation assembly may not only be configured to isolate an interference signal between different antenna subarrays, but also be configured to isolate an interference signal between different antenna elements.

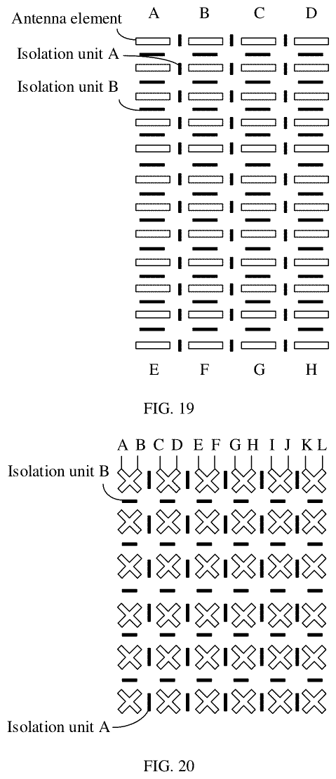

FIG. 19 and FIG. 20 each are a diagram of isolation units located between antenna subarrays and between antenna elements. The antenna subarrays in FIG. 19 are similar to the antenna subarrays in FIG. 17. For details, refer to the descriptions about the antenna subarrays in FIG. 17. The antenna subarrays in FIG. 20 are similar to the antenna subarrays in FIG. 18. For details, refer to the descriptions about the antenna subarrays in FIG. 18. Details are not described again. A difference lies in that an isolation assembly in FIG. 19 or FIG. 20 includes an isolation unit (an isolation unit A shown in the figure) located between the antenna subarrays, and further includes an isolation unit (an isolation unit B shown in the figure) located between the antenna elements. Although all isolation units in the figure are located at different locations, principles for isolating interference signals at different locations are the same. For understanding, refer to the foregoing descriptions about different materials used to isolate interference signals and the descriptions about the isolation units in FIG. 16 to FIG. 18. Details are not described again.

It should be understood that FIG. 17 to FIG. 20 each show merely a possible distribution of isolation units, and shall not constitute any limitation on this application. Due to special features of a dual-polarized antenna, an isolation unit cannot be disposed between two subarrays that form the dual-polarized antenna. However, in an antenna array formed by an antenna of another form, an isolation unit may be still disposed between every two adjacent antenna subarrays. In addition, the isolation unit between every two groups of antenna subarrays in FIG. 17 or FIG. 18 may alternatively be isolation units of another form. For a specific example, refer to FIG. 22.

It should be further understood that locations of isolation units shown in FIG. 17 to FIG. 20 are merely possible designs. The isolation unit is not limited to being disposed between two antenna elements that are adjacent in the horizontal direction or the vertical direction, and may be further disposed at another location.

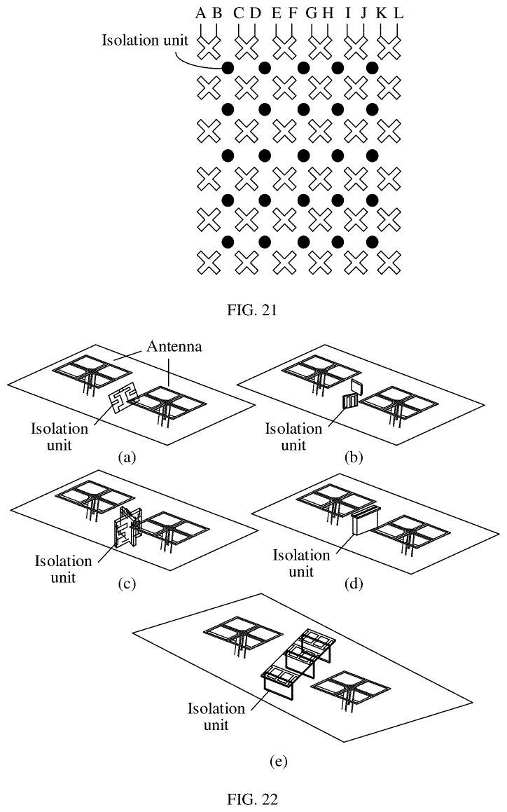

FIG. 21 is another diagram of isolation units located between antenna subarrays and between antenna elements. As shown in FIG. 21, a plurality of isolation units are located between every two adjacent antenna subarrays in a plurality of groups of antenna subarrays. If two antenna elements that form a cross-polarized antenna are referred to as one group of antenna elements, each isolation unit may be located at a center of four groups of antenna elements, in other words, located between two groups of antenna elements on a diagonal. It is easy to understand that disposing the isolation unit at the center of the four groups of antenna elements can reduce interference between different groups of antenna subarrays and reduce interference between different groups of antenna elements, has an isolation effect similar to that in FIG. 20, and can reduce a quantity of isolation units.

It should be understood that the foregoing shapes and locations of the isolation units shown with reference to FIG. 17 to FIG. 21 are all examples. A person skilled in the art may design isolation units of more shapes based on a same concept, and may also dispose isolation units at another location between the antenna subarrays and between the antenna elements, to improve isolation. This is not limited in this application.

FIG. 22 is another diagram of an isolation unit located between antenna subarrays. In an example, (a), (b), (c), (d) and (e) in FIG. 22 show isolation units of several different forms located between adjacent antennas. Although forms of the isolation units are different, principles for isolating interference signals are the same. For understanding, refer to the foregoing descriptions about different materials used to isolate interference signals and the descriptions about the isolation units in FIG. 16 to FIG. 20. Details are not described again.

It should be noted that FIG. 22 shows a possible antenna form. The figure not only shows antenna elements, but also shows feed networks and reflection plates that are connected to the antenna

It should be further understood that in a same antenna array, for example, in the N antenna subarrays in this application, an isolation unit in one or more shapes shown in FIG. 16 to FIG. 22 may be used, or an isolation unit in another shape may be used. This is not limited in this application.

The foregoing technologies in which the isolation assembly is disposed between the antenna subarrays (even between the antenna elements) and different routing designs are made for the feed networks of different radio frequency antenna links may be collectively referred to as high-isolation antenna technologies. According to these high-isolation antenna technologies, interference signals from different antenna subarrays can be canceled, and isolation between the antenna subarrays is improved, that is, isolation between the N radio frequency antenna links is improved.

In addition to the foregoing Solution 1 to Solution 3, a self-interference canceller is connected between a transmit channel and a receive channel of at least one of the N radio frequency antenna links provided in this application, as shown in FIG. 11. The self-interference canceller may be configured to cancel interference of a signal of the transmit channel of the link on the receive channel. For a circuit design of the self-interference canceller, refer to the foregoing related descriptions with reference to FIG. 7. Details are not described again. For ease of description, in this specification, a design solution in which a self-interference canceller is connected between a transmit channel and a receive channel of a same radio frequency antenna link is denoted as Solution 4.

In a possible design, a self-interference canceller is connected between a transmit channel and a receive channel of each of the N radio frequency antenna links, that is, there are N self-interference cancellers in total in the AAU. For example, as shown in FIG. 11, a self-interference canceller is connected between a transmit channel and a receive channel of each of the two radio frequency antenna links, and the AAU shown in FIG. 11 includes two self-interference cancellers in total. However, according to the design shown in FIG. 9, if N is 2, 2×2 (namely, 4) self-interference cancellers in total are included. It can be learned that a quantity of self-interference cancellers is reduced.

In other words, if the self-interference canceller is connected between the transmit channel and the receive channel of each of the N radio frequency antenna link, the N (that is, L=N) self-interference cancellers in total are required. However, in the design shown in FIG. 9, N×N self-interference cancellers are required. Therefore, in the AAU provided in this application, reduction in the quantity of self-interference cancellers is more significant as N increases.

Further, a feed network in the AAU includes a phase shifter, each feed network may include one or more phase shifters, and each phase shifter may be connected to one or more antenna elements. As shown in FIG. 11, a feed network includes two phase shifters, and each phase shifter is connected to three antenna elements.

Because the phase shifter may be configured to adjust a beam direction of a signal, more antenna elements may be used in an antenna subarray to receive a signal and send a signal. An increase in a quantity of antenna elements in an antenna array may cause greater freedom of the feed network. In other words, the feed network may have greater freedom to optimize an amplitude and/or a phase of the signal, to provide powerful support for optimizing higher isolation.

In addition, each phase shifter may be configured to adjust a phase of a signal transmitted or received by a connected antenna element, so that a phase difference also exists between downlink signals transmitted by antenna elements connected to different phase shifters in a same antenna subarray. Therefore, the downlink signals transmitted by the different antenna elements may be mutually canceled by controlling the phase difference, thereby reducing mutual interference.

It should be understood that although not shown in the figure, the feed network may further include another device, for example, an attenuator and a power splitter. This application includes but is not limited thereto.

FIG. 23 is another diagram of an AAU according to an embodiment of this application. In the AAU shown in FIG. 23, every two antenna subarrays, as one group, form a dual-polarized antenna array. An isolation unit may be disposed between groups of antenna subarrays or between every two adjacent dual-polarized antennas. For a specific location of the isolation unit in FIG. 23, refer to the foregoing descriptions with reference to FIG. 21. Details are not described again. Three columns of antenna elements are shown in the figure, and each column is one group of (namely, two) antenna subarrays. Therefore, the three groups (or three columns) of antenna subarrays are connected to six radio frequency channels. Each antenna subarray and a radio frequency channel connected to the antenna subarray belong to one radio frequency antenna link. A feed network in each radio frequency antenna link includes two phase shifters, and each phase shifter is connected to three antenna elements. For a relationship between the phase shifter and the antenna element, refer to the foregoing related descriptions. Details are not described again.

For ease of distinguishing, from left to right in the figure, connections between a 1^{st} group of antenna subarrays and radio frequency channels are shown by using solid lines, and connections between two groups of antenna subarrays on the right and radio frequency channels are shown by using dashed lines. In addition, for brevity, only two radio frequency channels are shown in the figure, and other radio frequency channels may be learned by referring to the structure shown in the figure.

In addition, a self-interference canceller may be connected between a transmit channel and a receive channel of each of N radio frequency antenna links. For a structure of the self-interference canceller, refer to the figure and related descriptions thereof. Details are not described again.

It should be understood that the foregoing describes the AAU provided in embodiments of this application with reference to a plurality of accompanying drawings. Based on a same concept, a person skilled in the art may further make simple transformations to obtain more possible structures through extension. All these structures shall fall within the protection scope of this application.

In embodiments of this application, both a design of a feed network and a design of disposing an isolation assembly for antenna subarrays can reduce mutual interference between different antenna subarrays. At least one of the two designs is applied to a plurality of radio frequency antenna links, so that mutual interference between different radio frequency antenna links can be reduced. In this way, interference received on a receive channel of each radio frequency antenna link is mainly from a downlink signal of a transmit channel of the link. Therefore, a self-interference canceller may be connected between the transmit channel and the receive channel of the radio frequency antenna link, to cancel the downlink signal from the transmit channel of the link, so as to reduce interference on the receive channel. In other words, in the solution provided in this application, there is no need to connect self-interference cancellers between transmit channels and receive channels of any two different radio frequency antenna links in the N radio frequency antenna links. This greatly reduces a quantity of self-interference cancellers, thereby lowering control complexity as well as circuit complexity.

In addition, an interference signal has a great impact on an ADC on the receive channel. As a result, the ADC may be saturated or automatic gain control may be enabled on the receive channel, causing significant deterioration of receiver sensitivity. Therefore, before a received signal enters the ADC, the interference signal may be weakened, to reduce the impact of the interference signal on the ADC.

The following provides two solutions for further reducing interference on a receive channel. The following provides descriptions in detail with reference to accompanying drawings.

In a possible design for further reducing interference on a receive channel, the receive channel of each radio frequency antenna link includes an LNA, an ADC, and a narrow band filter connected between the ADC and the LNA, where the narrow band filter is configured to filter out another frequency signal not at a preset frequency. For ease of description, in this specification, a design solution in which the narrow band filter is connected between the LNA and the ADC of the receive channel is denoted as Solution 5.

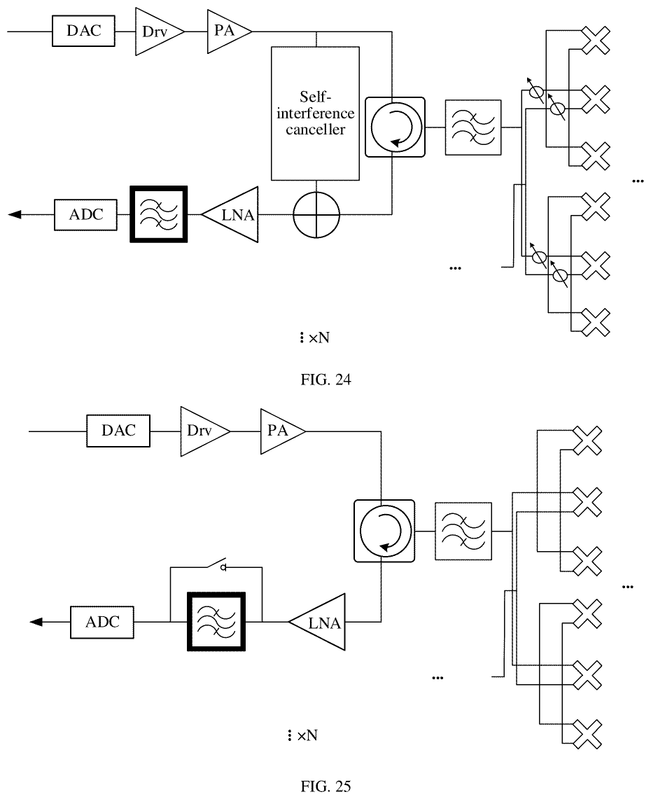

FIG. 24 is still another diagram of an AAU according to an embodiment of this application. For ease of understanding and description, FIG. 24 specifically shows a radio frequency antenna link in the AAU. In the radio frequency antenna link shown in FIG. 24, a narrow band filter (narrow band filter) is connected between an ADC and an LNA of a receive channel. The narrow band filter is a filter with a narrow passband, and allows only frequencies within a very narrow range to pass through while attenuating other frequencies. In this embodiment of this application, the narrow band filter may allow a signal of a preset frequency (for example, the frequency f₃ in FIG. 5) to be passed through, and attenuate a signal of another frequency, causing the signal of the another frequency to be incapable of passing through the narrow band filter. That is, in the subband-duplex working mode shown in FIG. 5, an uplink signal can pass through, while other signals are filtered out, causing low interference on a signal entering the ADC.

Because a communication device to which the AAU belongs may need to switch between several different working modes, the narrow band filter may be used in some working modes, for example, a subband-duplex working mode, and is not used in some other working modes, for example, FDD, TDD, and partial full-duplex working modes. Therefore, an improvement may be made based on FIG. 24, and a switch element is added to control a signal to flow to the ADC over different paths in different working modes.

In some embodiments, the receive channel of each radio frequency antenna link further includes a switch element, and the switch element in each radio frequency antenna link is configured to control a received signal to flow to the ADC through or not through the narrow band filter. It should be understood that a design solution in which a signal flow direction is controlled by the switch element may be considered as an optional solution provided based on Solution 5.

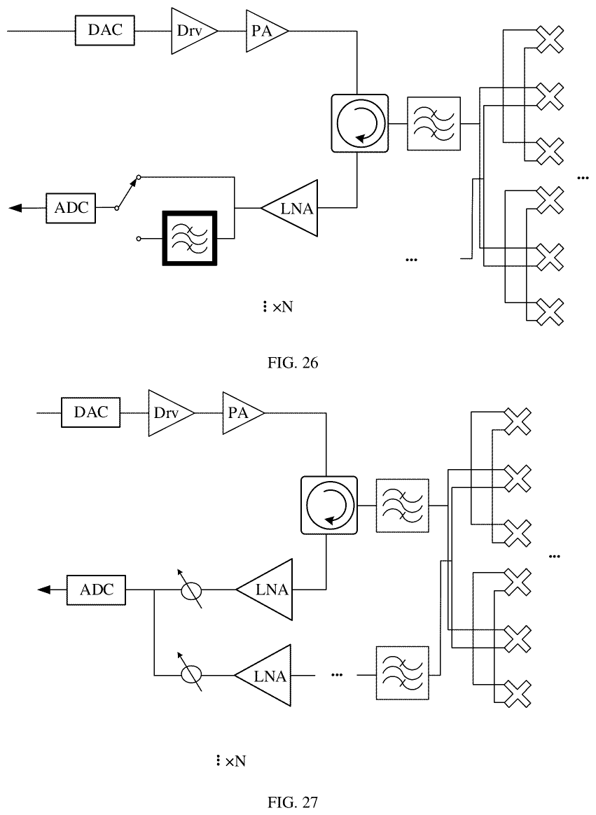

FIG. 25 and FIG. 26 are another two diagrams of an AAU according to an embodiment of this application. Based on the current existing AAU shown in FIG. 10, a switch element is added in FIG. 25 and FIG. 26. For content that is the same as that in FIG. 10, refer to the related descriptions in FIG. 10. Details are not described again.

In FIG. 25, the switch element is connected in parallel to both ends of a narrow band filter. The switch element may be, for example, a single-pole single-throw switch, and is disconnected in the subband-duplex working mode, so that a signal flows to an ADC through the narrow band filter; and is connected in another working mode, so that the signal flows to the ADC through the switch element instead of the narrow band filter.

In FIG. 26, the narrow band filter may alternatively be connected in parallel with a conductor and connected between the switch element and an LNA. The switch element may be, for example, a single-pole double-throw switch. In the subband-duplex working mode, a branch on which a narrow band filter is located is conducted, so that a signal flows to an ADC through the narrow band filter. In another working mode, a branch on which the conductor is located is conducted, and a port of a branch on which the narrow band filter is located is bypassed, so that the signal flows to the ADC through the conductor instead of the narrow band filter. In this way, switching may be performed between the two branches: one with the narrow band filter and one without the narrow band filter, to adapt to different working modes. FIG. 26 is merely an example. After the narrow band filter is connected in parallel to the conductor, the narrow band filter may alternatively be connected between the switch element and the ADC, which can also achieve the effect of switching between the two branches.

It should be understood that the switch elements and connection relationships between the switch elements and other devices on receive channels shown in FIG. 25 and FIG. 26 are merely examples. Based on a same concept, a person skilled in the art may make equivalent transformations to obtain more possible circuit designs. All these transformations shall fall within the protection scope of this application.

In another possible design for further reducing interference on a receive channel, at least two of N antenna subarrays are separately connected to an ADC on a same receive channel through phase shifters, and each phase shifter is configured to adjust phases of an uplink signal and a downlink signal that are received by the connected antenna subarray. For ease of description, in this specification, a design solution in which a plurality of antenna subarrays are connected to an ADC on a same receive channel is denoted as Solution 6.

FIG. 27 is still another diagram of an AAU according to an embodiment of this application. Based on the current existing AAU shown in FIG. 10, a plurality of antenna subarrays are separately connected to an ADC on a same receive channel through phase shifters in FIG. 27. For content that is the same as that in FIG. 10, refer to the related descriptions in FIG. 10. Details are not described again.

For ease of understanding, FIG. 27 shows an example in which two antenna subarrays are separately connected to an ADC on a same receive channel through phase shifters. Connecting to the ADC may be specifically connecting to an input end of the ADC, that is, an uplink signal and a downlink signal received by the two antenna subarrays are separately phase shifted through the phase shifter and then enter the ADC. FIG. 27 is merely an example. A quantity of antenna subarrays that are connected to the ADC on the same receive channel is not limited in this Connecting the plurality of antenna subarrays to the same receive channel may also be understood as combining the plurality of antenna subarrays with one receive channel. In such a design, phases of the plurality of antenna subarrays may be adjusted (or optimized), to enhance an uplink signal and weaken a downlink signal on a same receive channel. In addition, on the receive channel of each of the N radio frequency antenna links, the uplink signal can be enhanced and the downlink signal can be weakened in a same manner.

It should be understood that an objective of phase adjustment is to perform in-phase superposition on uplink signals and perform out-of-phase cancellation on downlink signals through the adjustment. The in-phase superposition on the uplink signals means that uplink signals from different antenna subarrays are superimposed in phase and are enhanced. That the uplink signals from the different antenna subarrays are in phase may specifically mean that there is a phase difference of an integer multiple of 27 between the uplink signals from the different antenna subarrays. The out-of-phase cancellation on the downlink signals means that downlink signals from different antenna subarrays are canceled out of phase and energy is weakened. That the downlink signals from the different antenna subarrays are out of phase may specifically mean that there is a phase difference of an odd multiple of a between the downlink signals from the different antenna subarrays.

That the phase difference between the uplink signals from the different antenna subarrays is the integer multiple of 21, and the phase difference between the downlink signals from the different antenna subarrays is the odd multiple of a is an ideal objective of the phase adjustment. In an actual application, continuous adjustment and optimization may be performed, so that the phase difference between the uplink signals from the different antenna subarrays approaches the integer multiple of 21, and the phase difference between the downlink signals from the different antenna subarrays approaches the odd multiple of T.

In a possible design, the N antenna subarrays in the AAU may be separately connected to an ADC on each receive channel of N receive channels through phase shifters. In other words, the N antenna subarrays in the AAU may be separately connected to an ADC on a same receive channel through phase shifters, and an ADC on a receive channel of each of the N radio frequency antenna links in the AAU is connected to the N antenna subarrays. In this way, an N×N fully-connected network is formed between the N antenna subarrays and the N receive channels.

According to the foregoing design, the N antenna subarrays may be combined with one receive channel, and each of the N receive channels is combined with the N antenna subarrays. In this way, N phase shifters connected to the N antenna subarrays may respectively perform phase adjustment (or optimization) on signals of the antenna subarrays connected to the N phase shifters, so that on each of the N receive channels, an uplink signal can be enhanced and a downlink signal can be weakened, thereby helping improve receive performance.

It should be understood that, in the plurality of solutions provided above, the solutions may be combined with each other to achieve effects of reducing interference and improving receive performance.

For example, one or more of Solution 1 to Solution 3 may be used in combination with Solution 4, and based on this, may be further combined with Solution 5 or Solution 6 to achieve second level interference reduction. One or more of Solution 1 to Solution 3 may be used in combination with Solution 4 to achieve first level interference reduction, and Solution 5 or Solution 6 may achieve second level interference reduction.

Based on the combination of the one or more of Solution 1 to Solution 3 with Solution 4, before an LNA on the receive channel, an interference signal may be reduced below a blocking level (for example, may be the maximum power allowed for the receiving dynamic range mentioned in the foregoing related descriptions about receiver blocking), or may be partially reduced but does not necessarily need to be reduced below the blocking level. Although the reduction in the interference signal does not meet the requirement of being lower than the blocking level, the weakened interference signal has little impact on the LNA on the receive channel. For example, there are few non-linear components on the LNA, which has little impact on receiver sensitivity. However, the weakened interference signal has large impact on the ADC on the receive channel. As a result, the ADC may be saturated or automatic gain control may not be enabled on the receive channel, causing significant deterioration of the receiver sensitivity.

For the large impact of the interference signal on the ADC, Solution 5 or Solution 6 may be further used, to reduce interference on the receive channel, so that interference is reduced to a lower level before the received signal enters the ADC.

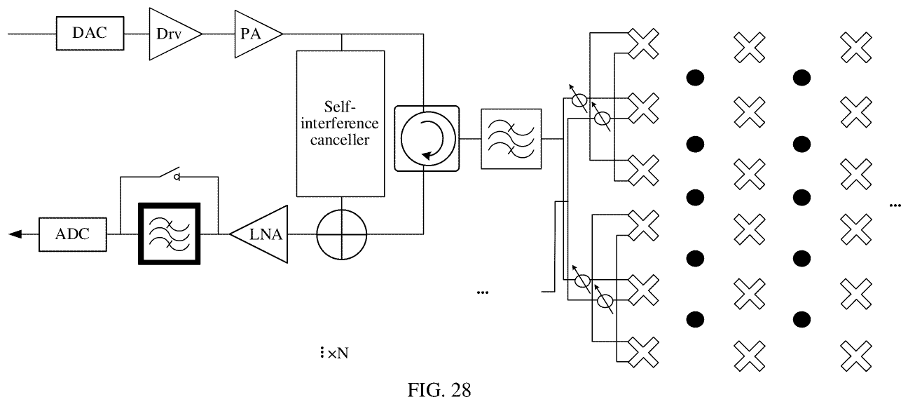

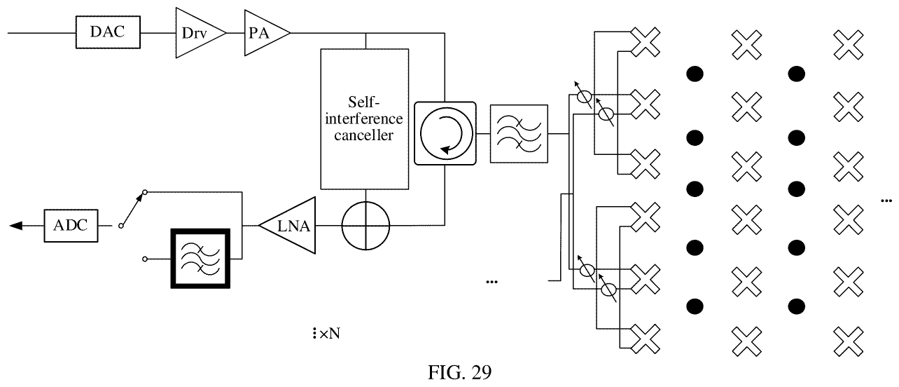

FIG. 28 to FIG. 30 are still other three diagrams of an AAU according to an embodiment of this application. Based on the AAU shown in FIG. 23, the narrow band filters and the switch elements shown in FIG. 25 and FIG. 26 are added in FIG. 28 and FIG. 29. This is equivalent to combining Solution 3, Solution 4, and Solution 5. For content that is the same as that in FIG. 23, FIG. 25, or FIG. 26, refer to the related descriptions in FIG. 23, FIG. 25, or FIG. 26. Details are not described again.

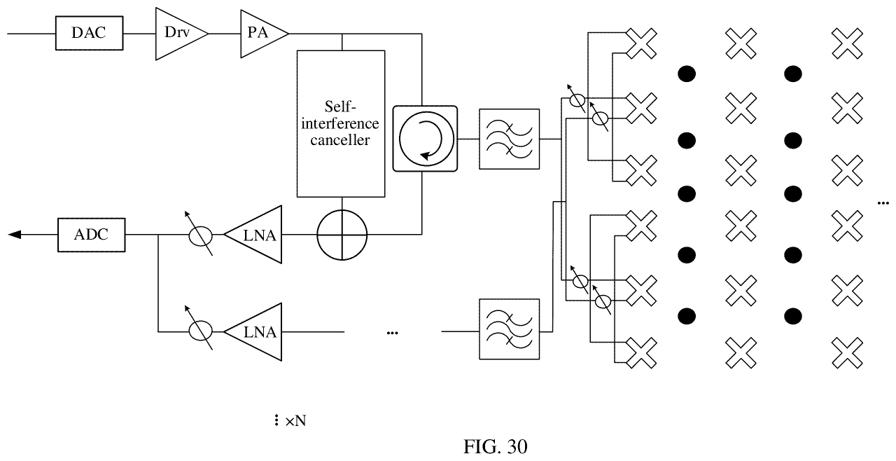

Based on the AAU shown in FIG. 23 and according to the method shown in FIG. 28, a plurality of antenna subarrays are separately connected to an ADC on a same receive channel through phase shifters in FIG. 30. This is equivalent to combining Solution 3, Solution 4, and Solution 6. For content that is the same as that in FIG. 23 or FIG. 28, refer to the related descriptions in FIG. 23 or FIG. 28. Details are not described again.

It should be understood that, although not shown in the figure, Solution 1 and Solution 2 may be further combined with any combination solution in FIG. 28 to FIG. 30, to obtain a better effect of reducing interference.

In embodiments of this application, both a design of a feed network and a design of disposing an isolation assembly for antenna subarrays can reduce mutual interference between different antenna subarrays. At least one of the two designs is applied to a plurality of radio frequency antenna links, so that mutual interference between different radio frequency antenna links can be reduced. In this way, interference received on a receive channel of each radio frequency antenna link is mainly from a downlink signal of a transmit channel of the link. Therefore, a self-interference canceller may be connected between the transmit channel and the receive channel of the radio frequency antenna link, to cancel the downlink signal from the transmit channel of the link, so as to reduce interference on the receive channel. In other words, in the solution provided in this application, there is no need to connect self-interference cancellers between transmit channels and receive channels of any two different radio frequency antenna links in the N radio frequency antenna links. This greatly reduces a quantity of self-interference cancellers, thereby lowering control complexity as well as circuit complexity.

In addition, a design in which a narrow band filter is added on the receive channel or a plurality of antenna subarrays are connected to an ADC on a same receive channel to adjust a phase can implement second level interference reduction on the receive channel, so that impact of an interference signal on each receive channel in an AAU can be further reduced, thereby improving receive performance.

This application further provides a communication device. The communication device may include an AAU. The AAU may be the AAU shown with reference to any one of FIG. 11 and FIG. 23 to FIG. 30, or may be an AAU that is not shown in the figure but may be obtained based on any one of the foregoing solutions or a combination of any plurality of the foregoing solutions. In some embodiments, the communication device further includes a BBU. In some embodiments, the communication device is a network device. In some embodiments, the communication device is a terminal device.

It should be understood that the communication device may alternatively include an AAU and another module that may be configured to implement a function that is the same as or similar to that of a BBU. This is not limited in this application.

The AAU provided in this application is applied in the communication device, in comparison with an architecture of some approaches of a base station whose antenna is for both reception and transmission, a quantity of self-interference cancellers can be greatly reduced, and problems of high circuit complexity and high control complexity caused by an N×N fully-connected network can be resolved; and in comparison with a solution of some approaches in which a transmit antenna and a receive antenna are separated, a size of a base station device may not be limited, and a transmit antenna aperture and a receive antenna aperture are no longer limited in size reduction due to a technical obstacle that the transmit antenna and the receive antenna are separated, thereby helping obtain larger uplink and downlink coverage.

The foregoing descriptions are merely specific embodiments of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. An active antenna unit, comprising N radio frequency antenna links and L self-interference cancellers, wherein N is an integer greater than 1, and L is a positive integer less than or equal to N; each of the N radio frequency antenna links comprises a transmit channel, a receive channel, a feed network connected to the transmit channel and the receive channel, and an antenna subarray connected to the feed network, the feed network is configured to feed power to the antenna subarray, and the antenna subarray is configured to: transmit a signal and receive a signal; and a self-interference canceller is connected between a transmit channel and a receive channel of at least one of the N radio frequency antenna links, and the self-interference canceller is configured to cancel a signal that is on the receive channel of the radio frequency antenna link of the self-interference canceller and that is from the transmit channel of the same radio frequency antenna link; and
the N radio frequency antenna links meet at least one of the following:
traces of feed networks of at least two of the N radio frequency antenna links are different; or
an isolation assembly is disposed between N antenna subarrays of the N radio frequency antenna links, and the isolation assembly is configured to isolate a signal between the N antenna subarrays.

2. The active antenna unit according to claim 1, wherein each of the N antenna subarrays comprises a plurality of antenna elements, the feed network in each of the N radio frequency antenna links comprises one or more phase shifters, and each phase shifter is connected to one or more antenna elements.

3. The active antenna unit according to claim 1, wherein the isolation assembly comprises M decoupling units located above the N antenna subarrays, and M is an integer greater than or equal to N, wherein a decoupling unit located above a first antenna subarray is configured to reflect a part of a received signal, to cancel, by using the reflected signal, a signal that is from another antenna subarray and that is in a first receive channel, the first antenna subarray is any one of the N antenna subarrays, the first receive channel is a receive channel connected to the first antenna subarray, and the another antenna subarray is one or more of antenna subarrays in the N antenna subarrays other than the first antenna subarray.

4. The active antenna unit according to claim 1, wherein the isolation assembly comprises at least one isolation unit located between adjacent antenna subarrays in the N antenna subarrays, and the at least one isolation unit located between the adjacent antenna subarrays is configured to isolate an interference signal between at least some of the N antenna subarrays.

5. The active antenna unit according to claim 4, wherein each of the N antenna subarrays comprises a plurality of antenna elements, the isolation assembly further comprises at least one isolation unit located between adjacent antenna elements in each antenna subarray, and the at least one isolation unit located between the adjacent antenna elements is configured to isolate an interference signal between at least some of the plurality of antenna elements.

6. The active antenna unit according to claim 4, wherein the isolation unit is made of one or more of a wave-absorbing material, a scattering material, or a metamaterial.

7. The active antenna unit according to claim 1, wherein the receive channel of each radio frequency antenna link comprises a low noise amplifier (LNA), an analog-to-digital converter (ADC), and a narrow band filter connected between the ADC and the LNA, and the narrow band filter is configured to filter out another signal not at a preset frequency.

8. The active antenna unit according to claim 7, wherein the receive channel of each radio frequency antenna link further comprises a switch element, and the switch element is configured to control a received signal to flow to the ADC through or not through the narrow band filter.

9. The active antenna unit according to claim 1, wherein at least two of the N antenna subarrays are separately connected to an ADC on a same receive channel through phase shifters, and the phase shifter is configured to adjust phases of an uplink signal and a downlink signal that are received by a connected antenna subarray.

10. The active antenna unit according to claim 1, wherein L is equal to N.

11. A communication device, comprising:
a baseband unit, and
an active antenna unit comprising N radio frequency antenna links and L self-interference cancellers, wherein N is an integer greater than 1, and L is a positive integer less than or equal to N; each of the N radio frequency antenna links comprises a transmit channel, a receive channel, a feed network connected to the transmit channel and the receive channel, and an antenna subarray connected to the feed network, the feed network is configured to feed power to the antenna subarray, and the antenna subarray is configured to: transmit a signal and receive a signal; and a self-interference canceller is connected between a transmit channel and a receive channel of at least one of the N radio frequency antenna links, and the self-interference canceller is configured to cancel a signal that is on the receive channel of the radio frequency antenna link of the self-interference canceller and that is from the transmit channel of the same radio frequency antenna link; and
the N radio frequency antenna links meet at least one of the following:
traces of feed networks of at least two of the N radio frequency antenna links are different; or
an isolation assembly is disposed between N antenna subarrays of the N radio frequency antenna links, and the isolation assembly is configured to isolate a signal between the N antenna subarrays.

12. The communication device according to claim 11, wherein each of the N antenna subarrays comprises a plurality of antenna elements, the feed network in each of the N radio frequency antenna links comprises one or more phase shifters, and each phase shifter is connected to one or more antenna elements.

13. The communication device according to claim 11, wherein the isolation assembly comprises M decoupling units located above the N antenna subarrays, and M is an integer greater than or equal to N, wherein a decoupling unit located above a first antenna subarray is configured to reflect a part of a received signal, to cancel, by using the reflected signal, a signal that is from another antenna subarray and that is in a first receive channel, the first antenna subarray is any one of the N antenna subarrays, the first receive channel is a receive channel connected to the first antenna subarray, and the another antenna subarray is one or more of antenna subarrays in the N antenna subarrays other than the first antenna subarray.

14. The communication device according to claim 11, wherein the isolation assembly comprises at least one isolation unit located between adjacent antenna subarrays in the N antenna subarrays, and the at least one isolation unit located between the adjacent antenna subarrays is configured to isolate an interference signal between at least some of the N antenna subarrays.

15. The communication device according to claim 14, wherein each of the N antenna subarrays comprises a plurality of antenna elements, the isolation assembly further comprises at least one isolation unit located between adjacent antenna elements in each antenna subarray, and the at least one isolation unit located between the adjacent antenna elements is configured to isolate an interference signal between at least some of the plurality of antenna elements.
